(19) United States
(12) Patent Application Publication
(10) Pub. No.: US 2008/0098331 A1
(43) Pub. Date: Apr. 24, 2008

(54) Portable Multifunction Device with Soft Keyboards

(76) Inventors: Gregory Novick, Santa Clara, CA (US); Stephen O. Lemay, San Francisco, CA (US); Kenneth Kocienda, Sunnyvale, CA (US); Bas Ording, San Francisco, CA (US)

Correspondence Address: MORGAN LEWIS & BOCKIUS LLP/ APPLE COMPUTER INC., 2 PALO ALTO SQUARE, 3000 EL CAMINO REAL, PALO ALTO, CA, 94306, US

(21) Appl. No.: 11/961,663

(22) Filed: Dec. 20, 2007

Related U.S. Application Data
(63) Continuation-in-part of application No. 11/459,606, filed on Jul. 24, 2006.
(63) Continuation-in-part of application No. 11/459,615, filed on Jul. 24, 2006.
(63) Continuation-in-part of application No. 11/228,700, filed on Sep. 16, 2005.
(60) Provisional application No. 60/937,993, filed on Jun. 29, 2007.
(60) Provisional application No. 60/946,714, filed on Jun. 27, 2007.
(60) Provisional application No. 60/879,469, filed on Jan. 8, 2007.
(60) Provisional application No. 60/879,253, filed on Jan. 7, 2007.

(51) Int. Cl. G06F 3/048

(52) U.S. Cl. 715/835

(57) ABSTRACT

A portable multifunction device displays a first icon and a second icon on its touch screen display. In response to a sequence of finger movements across the first and second icons, wherein the finger stays in contact with the touch screen display during the movements, the portable device highlights the first icon for at least a predefined time period if a parameter associated with the finger's position relative to the touch screen display meets a first predefined condition and then highlights the second icon for at least the predefined time period if the parameter associated with the finger's position relative to the touch screen display meets a second predefined condition.

### RELATED APPLICATIONS

This application claims priority to U.S. Provisional Patent Application Nos. 60/937,993, “Portable Multifunction Device,” filed Jun. 29, 2007; 60/946,714, “Portable Multifunction Device with Soft Keyboards,” filed Jun. 27, 2007; 60/879,469, “Portable Multifunction Device,” filed Jan. 8, 2007; 60/879,253, “Portable Multifunction Device,” filed Jan. 7, 2007. All of these applications are incorporated by reference herein in their entirety.

This application is a continuation-in-part of U.S. patent application Ser. Nos. 11/459,606, “Keyboards for Portable Electronic Devices,” filed Jul. 24, 2006; 11/459,615, “Touch Screen Keyboards for Portable Electronic Devices,” filed Jul. 24, 2006; and U.S. patent application Ser. No. 11/228,700, “Operation of a Computer with a Touch Screen Interface,” filed Sep. 16, 2005. All of these applications are incorporated by reference herein in their entirety.

This application is related to the following applications: (1) U.S. patent application Ser. No. 10/188,182, “Touch Pad For Handheld Device,” filed Jul. 1, 2002; (2) U.S. patent application Ser. No. 10/722,948, “Touch Pad For Handheld Device,” filed Nov. 25, 2003; (3) U.S. patent application Ser. No. 10/643,256, “Movable Touch Pad With Added Functionality,” filed Aug. 18, 2003; (4) U.S. patent application Ser. No. 10/654,108, “Ambidextrous Mouse,” filed Sep. 2, 2003; (5) U.S. patent application Ser. No. 10/840,862, “Multipoint Touchscreen,” filed May 6, 2004; (6) U.S. patent application Ser. No. 10/903,964, “Gestures For Touch Sensitive Input Devices,” filed Jul. 30, 2004; (7) U.S. patent application Ser. No. 11/038,590, “Mode-Based Graphical User Interfaces For Touch Sensitive Input Devices” filed Jan. 18, 2005; (8) U.S. patent application Ser. No. 11/057,050, “Display Actuator,” filed Feb. 11, 2005; (9) U.S. Provisional Patent Application No. 60/658,777, “Multi-Functional Hand-Held Device,” filed Mar. 4, 2005; (10) U.S. patent application Ser. No. 11/367,749, “Multi-Functional Hand-Held Device,” filed Mar. 3, 2006; and (11) U.S. Patent Application No. and 60/824,769, “Portable Multifunction Device,” filed Sep. 6, 2006. All of these applications are incorporated by reference herein in their entirety.

### TECHNICAL FIELD

The disclosed embodiments relate generally to portable electronic devices, and more particularly, to portable devices that have soft keyboards.

### BACKGROUND

As portable electronic devices become more compact, and the number of functions performed by a given device increase, it has become a significant challenge to design a user interface that allows users to easily interact with a multifunction device. This challenge is particular significant for handheld portable devices, which have much smaller screens than desktop or laptop computers. This situation is unfortunate because the user interface is the gateway through which users receive not only content but also responses to user actions or behaviors, including user attempts to access a device's features, tools, and functions. Some portable communication devices (e.g., mobile telephones, sometimes called mobile phones, cell phones, cellular telephones, and the like) have resorted to adding more pushbuttons, increasing the density of push buttons, overloading the functions of pushbuttons, or using complex menu systems to allow a user to access, store and manipulate data. These conventional user interfaces often result in complicated key sequences and menu hierarchies that must be memorized by the user.

Many conventional user interfaces, such as those that include physical pushbuttons, are also inflexible. This is unfortunate because it may prevent a user interface from being configured and/or adapted by either an application running on the portable device or by users. When coupled with the time consuming requirement to memorize multiple key sequences and menu hierarchies, and the difficulty in activating a desired pushbutton, such inflexibility is frustrating to most users.

Although soft keyboards (also known as “virtual keyboards”) on the touch screen of a portable device may improve the device's usability, most of them are merely replicas of existing physical keyboards. Their designers have not fully explored the significant flexibility offered by a touch screen display. For example, a portable device usually has one soft keyboard for all users. But because different users have difference eyesight and/or finger sizes, this one-size-fit-all approach hardly meets different needs by different groups of users. Moreover, existing soft keyboard designs rarely provide efficient key input methods that leverage off the unique features inherent in the operations of touch screen displays.

Accordingly, there is a need for portable multifunction devices with more transparent and intuitive soft keyboards that are easy to use, configure, and/or adapt. Such keyboards increase the effectiveness, efficiency and user satisfaction with portable multifunction devices.

### SUMMARY

The above deficiencies and other problems associated with user interfaces for portable devices are reduced or eliminated by the disclosed portable multifunction device. In some embodiments, the device has a touch-sensitive display (also known as a “touch screen”) with a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive display. In some embodiments, the functions may include telephoning, video conferencing, e-mailing, instant messaging, blogging, digital photographing, digital videoing, web browsing, digital music playing, and/or digital video playing. Instructions for performing these functions may be included in a computer program product configured for execution by one or more processors.

One aspect of the invention involves a computer-implemented method performed by a portable multifunction device with a touch screen display. The portable device displays first key icon and second key icon on the touch screen display. Both the first and second key icons are part of a soft keyboard. In response to a sequence of finger movements across the first and second icons, wherein the finger stays in contact with the touch screen display during the movements, the portable device highlights the first icon for a predefined time period if a parameter associated with the finger's position relative to the touch screen display meets a first predefined condition and then highlights the second icon for the predefined time period if the parameter associated with the finger's position relative to the touch screen display meets a second predefined condition.

Another aspect of the invention involves a computer-implemented method performed by a portable multifunction device with a touch screen display. The portable device displays a first icon and a second icon on the touch screen display. In response to a sequence of finger movements across the first and second icons, wherein the finger stays in contact with the touch screen display during the movements, the portable device alters the first icon's appearance for a predefined time period if the finger moves within a predefined distance from the first icon and then moves away from the first icon and then alters the second icon's appearance for the predefined time period when the finger moves within the predefined distance from the second icon and then moves away from the second icon.

Another aspect of the invention involves a computer-implemented method performed by a portable multifunction device with a touch screen display. The portable device displays multiple icons including a first icon and a second icon on the touch screen display. In response to a sequence of finger movements across the first and second icons, wherein the finger stays in contact with the touch screen display during the movements, the portable device highlights the first icon after a parameter associated with the finger and the touch screen display increases beyond a first predefined threshold level and then decreases below a second predefined threshold level. The portable device highlights the second icon after the parameter associated with the finger and the touch screen display increases beyond the first predefined threshold level and then decreases below the second predefined threshold level.

Another aspect of the invention involves a computer-implemented method performed by a portable multifunction device with a touch screen display. The portable device displays a first keyboard on the touch screen display and the first keyboard includes at least one multi-symbol key icon. Upon detecting a user selection of the multi-symbol key icon, the portable device replaces the first keyboard with a second keyboard. In particular, the second keyboard includes multiple single-symbol key icons, each single-symbol key icon corresponding to a respective symbol associated with the multi-symbol key icon.

Another aspect of the invention involves a graphical user interface on a portable multifunction device with a touch screen display. The graphical user interface includes first and second key icons, which are part of a soft keyboard. The soft keyboard is configured such that: in response to a sequence of finger movements across the first and second icons, wherein the finger stays in contact with the touch screen display during the movements, the first key icon is highlighted if a parameter associated with a finger's position relative to the touch screen display meets a first predefined condition and is de-highlighted if the parameter meets a second predefined condition; the second key icon is highlighted when the parameter meets a third predefined condition. A symbol corresponding to the second key icon is entered into a predefined region of the graphical user interface when the finger is lifted off the touch screen display.

Another aspect of the invention involves a graphical user interface on a portable multifunction device with a touch screen display. The graphical user interface includes a first keyboard on the touch screen display, the first keyboard including a multi-symbol key icon. Upon the occurrence of a user selection of the multi-symbol key icon, the first keyboard is replaced with a second keyboard. The second keyboard includes multiple single-symbol key icons, each single-symbol key icon corresponding to a respective symbol associated with the multi-symbol key icon.

Another aspect of the invention involves a portable electronic device with a touch screen display with a plurality of user interface objects. The device includes one or more processors, memory, and a program stored in the memory and configured to be executed by the one or more processors. The program includes: instructions for displaying first icon and second icon on the touch screen display; instructions for detecting a sequence of finger movements across the first and second icons, wherein the finger stays in contact with the touch screen display during the movements; instructions for, in response to the sequence of finger movements across the first and second icons, highlighting the first icon for a predefined time period if a parameter associated with the finger's position relative to the touch screen display meets a first predefined condition and highlighting the second icon for the predefined time period if the parameter associated with the finger's position relative to the touch screen display meets a second predefined condition

Another aspect of the invention involves a computer-program product that includes a computer readable storage medium and a computer program mechanism embedded therein. The computer program mechanism includes instructions that, when executed by a portable electronic device, cause the device to: display first icon and second icon on the touch screen display; detect a sequence of finger movements across the first and second icons, wherein the finger stays in contact with the touch screen display during the movements; in response to the sequence of finger movements across the first and second icons, highlight the first icon for a predefined time period if a parameter associated with the finger's position relative to the touch screen display meets a first predefined condition and highlight the second icon for the predefined time period if the parameter associated with the finger's position relative to the touch screen display meets a second predefined condition.

Another aspect of the invention involves a portable electronic device with a touch screen display. The device includes: means for displaying first icon and second icon on the touch screen display; means for detecting a sequence of finger movements across the first and second icons, wherein the finger stays in contact with the touch screen display during the movements; means for, in response to the sequence of finger movements, highlighting the first icon for a predefined time period if a parameter associated with the finger's position relative to the touch screen display meets a first predefined condition and highlighting the second icon for the predefined time period if the parameter associated with the finger's position relative to the touch screen display meets a second predefined condition.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIGS. 1A and 1B are block diagrams illustrating portable multifunction devices with touch-sensitive displays in accordance with some embodiments.

FIG. 2 illustrates a portable multifunction device having a touch screen in accordance with some embodiments.

FIG. 3 illustrates an exemplary user interface for unlocking a portable electronic device in accordance with some embodiments.

FIGS. 4A and 4B illustrate exemplary user interfaces for a menu of applications on a portable multifunction device in accordance with some embodiments.

FIG. 5 is a flow diagram illustrating a first process for highlighting/de-highlighting some key icons of a soft keyboard in response to finger contacts with the soft keyboard in accordance with some embodiments.

FIG. 6 is a flow diagram illustrating a second process for visually distinguishing some key icons over other key icons of a soft keyboard in response to finger contacts with the soft keyboard in accordance with some embodiments.

FIG. 7 is a flow diagram illustrating a process for switching between soft keyboards in response to finger contacts with the soft keyboards in accordance with some embodiments.

FIGS. 8A through 8M illustrate exemplary soft keyboards in accordance with some embodiments.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first gesture could be termed a second gesture, and, similarly, a second gesture could be termed a first gesture, without departing from the scope of the present invention.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of a portable multifunction device, user interfaces for such devices, and associated processes for using such devices are described. In some embodiments, the device is a portable communications device such as a mobile telephone that also contains other functions, such as PDA and/or music player functions.

The user interface may include a physical click wheel in addition to a touch screen or a virtual click wheel displayed on the touch screen. A click wheel is a user-interface device that may provide navigation commands based on an angular displacement of the wheel or a point of contact with the wheel by a user of the device. A click wheel may also be used to provide a user command corresponding to selection of one or more items, for example, when the user of the device presses down on at least a portion of the wheel or the center of the wheel. Alternatively, breaking contact with a click wheel image on a touch screen surface may indicate a user command corresponding to selection. For simplicity, in the discussion that follows, a portable multifunction device that includes a touch screen is used as an exemplary embodiment. It should be understood, however, that some of the user interfaces and associated processes may be applied to other devices, such as personal computers and laptop computers, which may include one or more other physical user-interface devices, such as a physical click wheel, a physical keyboard, a mouse and/or a joystick.

The device supports a variety of applications, such as a telephone application, a video conferencing application, an e-mail application, an instant messaging application, a blogging application, a digital camera application, a digital video camera application, a web browsing application, a digital music player application, and/or a digital video player application.

The various applications that may be executed on the device may use at least one common physical user-interface device, such as the touch screen. One or more functions of the touch screen as well as corresponding information displayed on the device may be adjusted and/or varied from one application to the next and/or within a respective application. In this way, a common physical architecture (such as the touch screen) of the device may support the variety of applications with user interfaces that are intuitive and transparent.

The user interfaces may include one or more soft keyboard embodiments. The soft keyboard embodiments may include standard (QWERTY) and/or non-standard configurations of symbols on the displayed icons of the keyboard, such as those described in U.S. patent application Ser. Nos. 11/459,606, “Keyboards For Portable Electronic Devices,” filed Jul. 24, 2006, and 11/459,615, “Touch Screen Keyboards For Portable Electronic Devices,” filed Jul. 24, 2006, the contents of which are hereby incorporated by reference herein in their entirety. The keyboard embodiments may include a reduced number of icons (or soft keys) relative to the number of keys in existing physical keyboards, such as that for a typewriter. This may make it easier for users to select one or more icons in the keyboard, and thus, one or more corresponding symbols. The keyboard embodiments may be adaptive. For example, displayed icons may be modified in accordance with user actions, such as selecting one or more icons and/or one or more corresponding symbols. One or more applications on the portable device may utilize common and/or different keyboard embodiments. Thus, the keyboard embodiment used may be tailored to at least some of the applications. In some embodiments, one or more keyboard embodiments may be tailored to a respective user. For example, one or more keyboard embodiments may be tailored to a respective user based on a word usage history (lexicography, slang, individual usage) of the respective user. Some of the keyboard embodiments may be adjusted to reduce a probability of a user error when selecting one or more icons, and thus one or more symbols, when using the soft keyboard embodiments.

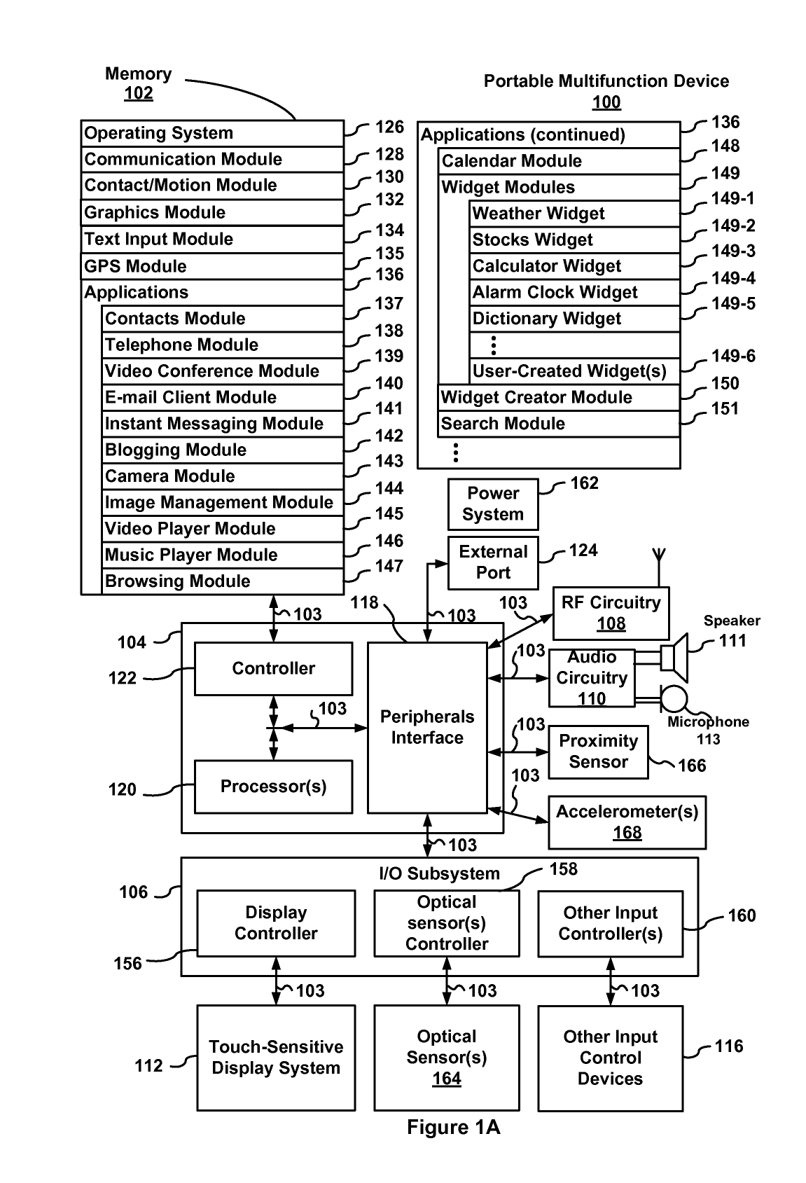

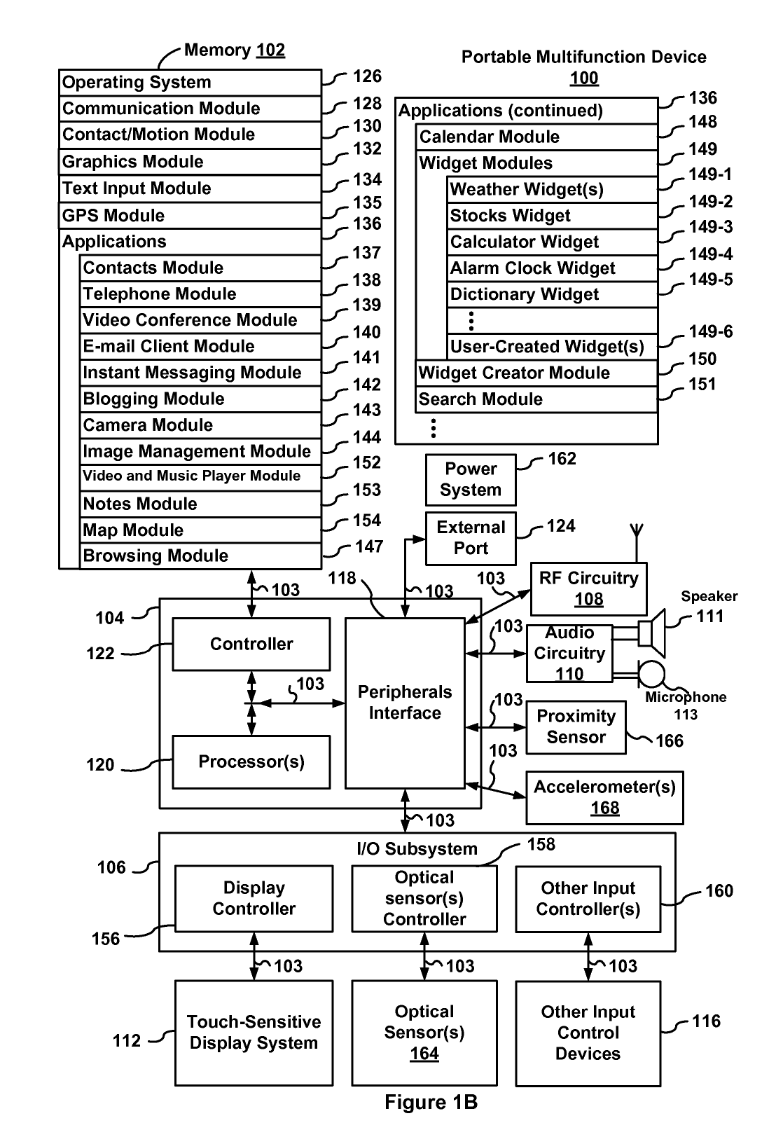

Attention is now directed towards embodiments of the device. FIGS. 1A and 1B are block diagrams illustrating portable multifunction devices 100 with touch-sensitive displays 112 in accordance with some embodiments. The touch-sensitive display 112 is sometimes called a “touch screen” for convenience, and may also be known as or called a touch-sensitive display system. The device 100 may include a memory 102 (which may include one or more computer readable storage mediums), a memory controller 122, one or more processing units (CPU's) 120, a peripherals interface 118, RF circuitry 108, audio circuitry 110, a speaker 111, a microphone 113, an input/output (I/O) subsystem 106, other input or control devices 116, and an external port 124. The device 100 may include one or more optical sensors 164. These components may communicate over one or more communication buses or signal lines 103.

It should be appreciated that the device 100 is only one example of a portable multifunction device 100, and that the device 100 may have more or fewer components than shown, may combine two or more components, or a may have a different configuration or arrangement of the components. The various components shown in FIGS. 1A and 1B may be implemented in hardware, software or a combination of hardware and software, including one or more signal processing and/or application specific integrated circuits.

Memory 102 may include high-speed random access memory and may also include non-volatile memory, such as one or more magnetic disk storage devices, flash memory devices, or other non-volatile solid-state memory devices. Access to memory 102 by other components of the device 100, such as the CPU 120 and the peripherals interface 118, may be controlled by the memory controller 122.

The peripherals interface 118 couples the input and output peripherals of the device to the CPU 120 and memory 102. The one or more processors 120 run or execute various software programs and/or sets of instructions stored in memory 102 to perform various functions for the device 100 and to process data.

In some embodiments, the peripherals interface 118, the CPU 120, and the memory controller 122 may be implemented on a single chip, such as a chip 104. In some other embodiments, they may be implemented on separate chips.

The RF (radio frequency) circuitry 108 receives and sends RF signals, also called electromagnetic signals. The RF circuitry 108 converts electrical signals to/from electromagnetic signals and communicates with communications networks and other communications devices via the electromagnetic signals. The RF circuitry 108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 108 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

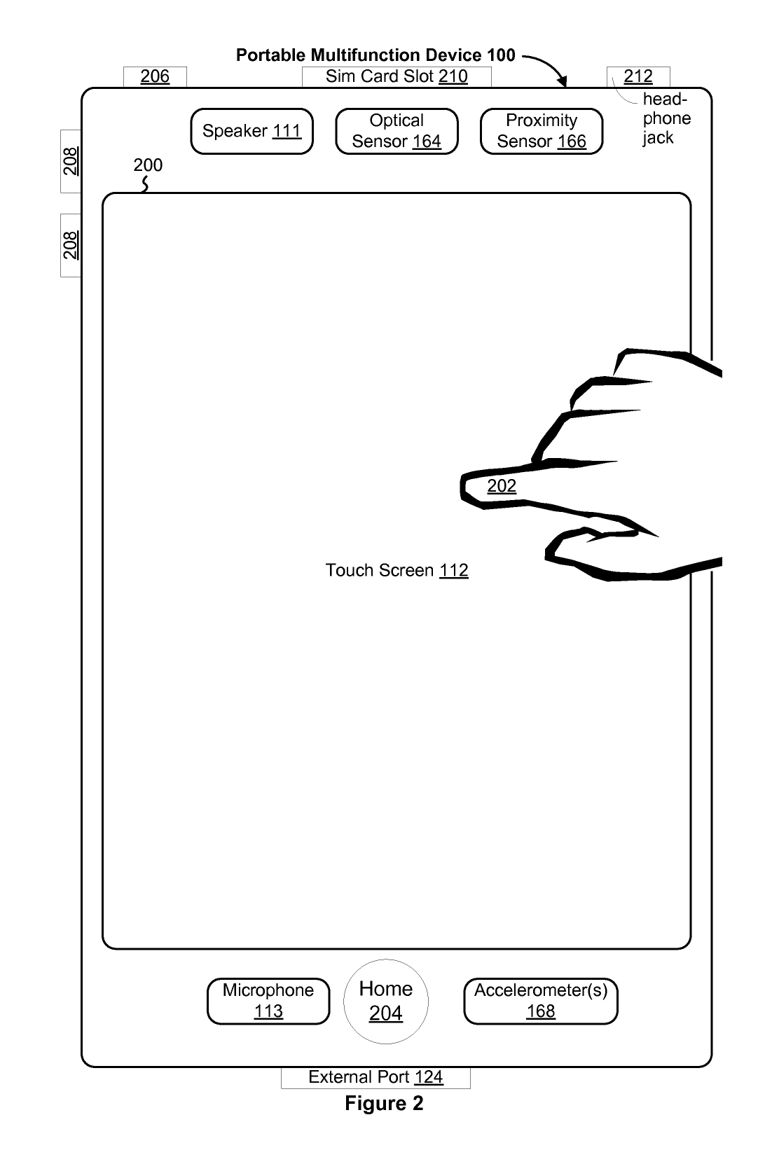

The audio circuitry 110, the speaker 111, and the microphone 113 provide an audio interface between a user and the device 100. The audio circuitry 110 receives audio data from the peripherals interface 118, converts the audio data to an electrical signal, and transmits the electrical signal to the speaker 111. The speaker 111 converts the electrical signal to human-audible sound waves. The audio circuitry 110 also receives electrical signals converted by the microphone 113 from sound waves. The audio circuitry 110 converts the electrical signal to audio data and transmits the audio data to the peripherals interface 118 for processing. Audio data may be retrieved from and/or transmitted to memory 102 and/or the RF circuitry 108 by the peripherals interface 118. In some embodiments, the audio circuitry 110 also includes a headset jack (e.g. 212, FIG. 2). The headset jack provides an interface between the audio circuitry 110 and removable audio input/output peripherals, such as output-only headphones or a headset with both output (e.g., a headphone for one or both ears) and input (e.g., a microphone).

The I/O subsystem 106 couples input/output peripherals on the device 100, such as the touch screen 112 and other input/control devices 116, to the peripherals interface 118. The I/O subsystem 106 may include a display controller 156 and one or more input controllers 160 for other input or control devices. The one or more input controllers 160 receive/send electrical signals from/to other input or control devices 116. The other input/control devices 116 may include physical buttons (e.g., push buttons, rocker buttons, etc.), dials, slider switches, joysticks, click wheels, and so forth. In some alternate embodiments, input controller(s) 160 may be coupled to any (or none) of the following: a keyboard, infrared port, USB port, and a pointer device such as a mouse. The one or more buttons (e.g., 208, FIG. 2) may include an up/down button for volume control of the speaker 111 and/or the microphone 113. The one or more buttons may include a push button (e.g., 206, FIG. 2). A quick press of the push button may disengage a lock of the touch screen 112 or begin a process that uses gestures on the touch screen to unlock the device, as described in U.S. patent application Ser. No. 11/322,549, “Unlocking a Device by Performing Gestures on an Unlock Image,” filed Dec. 23, 2005, which is hereby incorporated by reference herein in its entirety. A longer press of the push button (e.g., 206) may turn power to the device 100 on or off. The user may be able to customize a functionality of one or more of the buttons. The touch screen 112 is used to implement virtual or soft buttons and one or more soft keyboards.

The touch-sensitive touch screen 112 provides an input interface and an output interface between the device and a user. The display controller 156 receives and/or sends electrical signals from/to the touch screen 112. The touch screen 112 displays visual output to the user. The visual output may include graphics, text, icons, video, and any combination thereof (collectively termed “graphics”). In some embodiments, some or all of the visual output may correspond to user-interface objects, further details of which are described below.

A touch screen 112 has a touch-sensitive surface, sensor or set of sensors that accepts input from the user based on haptic and/or tactile contact. The touch screen 112 and the display controller 156 (along with any associated modules and/or sets of instructions in memory 102) detect contact (and any movement or breaking of the contact) on the touch screen 112 and converts the detected contact into interaction with user-interface objects (e.g., one or more soft keys, icons, web pages or images) that are displayed on the touch screen. In an exemplary embodiment, a point of contact between a touch screen 112 and the user corresponds to a finger of the user.

The touch screen 112 may use LCD (liquid crystal display) technology, or LPD (light emitting polymer display) technology, although other display technologies may be used in other embodiments. The touch screen 112 and the display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 112.

A touch-sensitive display in some embodiments of the touch screen 112 may be analogous to the multi-touch sensitive tablets described in the following U.S. Pat. Nos. 6,323,846 (Westerman et al.), 6,570,557 (Westerman et al.), and/or 6,677,932 (Westerman), and/or U.S. Patent Publication 2002/0015024A1, each of which is hereby incorporated by reference herein in their entirety. However, a touch screen 112 displays visual output from the portable device 100, whereas touch sensitive tablets do not provide visual output.

A touch-sensitive display in some embodiments of the touch screen 112 may be as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

The touch screen 112 may have a resolution in excess of 100 dpi. In an exemplary embodiment, the touch screen has a resolution of approximately 160 dpi. The user may make contact with the touch screen 112 using any suitable object or appendage, such as a stylus, a finger, and so forth. In some embodiments, the user interface is designed to work primarily with finger-based contacts and gestures, which are much less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, the device 100 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from the touch screen 112 or an extension of the touch-sensitive surface formed by the touch screen.

In some embodiments, the device 100 may include a physical or virtual click wheel as an input control device 116. A user may navigate among and interact with one or more graphical objects (henceforth referred to as icons) displayed in the touch screen 112 by rotating the click wheel or by moving a point of contact with the click wheel (e.g., where the amount of movement of the point of contact is measured by its angular displacement with respect to a center point of the click wheel). The click wheel may also be used to select one or more of the displayed icons. For example, the user may press down on at least a portion of the click wheel or an associated button. User commands and navigation commands provided by the user via the click wheel may be processed by an input controller 160 as well as one or more of the modules and/or sets of instructions in memory 102. For a virtual click wheel, the click wheel and click wheel controller may be part of the touch screen 112 and the display controller 156, respectively. For a virtual click wheel, the click wheel may be either an opaque or semitransparent object that appears and disappears on the touch screen display in response to user interaction with the device. In some embodiments, a virtual click wheel is displayed on the touch screen of a portable multifunction device and operated by user contact with the touch screen.

The device 100 also includes a power system 162 for powering the various components. The power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The device 100 may also include one or more optical sensors 164. FIGS. 1A and 1B show an optical sensor coupled to an optical sensor controller 158 in I/O subsystem 106. The optical sensor 164 may include charge-coupled device (CCD) or complementary metal-oxide semiconductor (CMOS) phototransistors. The optical sensor 164 receives light from the environment, projected through one or more lens, and converts the light to data representing an image. In conjunction with an imaging module 143 (also called a camera module), the optical sensor 164 may capture still images or video. In some embodiments, an optical sensor is located on the back of the device 100, opposite the touch screen display 112 on the front of the device, so that the touch screen display may be used as a viewfinder for either still and/or video image acquisition. In some embodiments, an optical sensor is located on the front of the device so that the user's image may be obtained for videoconferencing while the user views the other video conference participants on the touch screen display. In some embodiments, the position of the optical sensor 164 can be changed by the user (e.g., by rotating the lens and the sensor in the device housing) so that a single optical sensor 164 may be used along with the touch screen display for both video conferencing and still and/or video image acquisition.

The device 100 may also include one or more proximity sensors 166. FIGS. 1A and 1B show a proximity sensor 166 coupled to the peripherals interface 118. Alternately, the proximity sensor 166 may be coupled to an input controller 160 in the I/O subsystem 106. The proximity sensor 166 may perform as described in U.S. patent application Ser. No. 11/241,839, “Proximity Detector In Handheld Device,” filed Sep. 30, 2005; Ser. No. 11/240,788, “Proximity Detector In Handheld Device,” filed Sep. 30, 2005; Serial No. to be assigned, filed Jan. 7, 2007, “Using Ambient Light Sensor To Augment Proximity Sensor Output,” attorney docket no. 04860.P4851US1; Serial No. to be assigned, filed Oct. 24, 2006, “Automated Response To And Sensing Of User Activity In Portable Devices,” attorney docket no. 04860.P4293; and Serial No. to be assigned, filed Dec. 12, 2006, “Methods And Systems For Automatic Configuration Of Peripherals,” attorney docket no. 04860.P4634, which are hereby incorporated by reference herein in their entirety. In some embodiments, the proximity sensor turns off and disables the touch screen 112 when the multifunction device is placed near the user's ear (e.g., when the user is making a phone call). In some embodiments, the proximity sensor keeps the screen off when the device is in the user's pocket, purse, or other dark area to prevent unnecessary battery drainage when the device is a locked state.

The device 100 may also include one or more accelerometers 168. FIGS. 1A and 1B show an accelerometer 168 coupled to the peripherals interface 118. Alternately, the accelerometer 168 may be coupled to an input controller 160 in the I/O subsystem 106. The accelerometer 168 may perform as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are which are incorporated herein by reference. In some embodiments, information is displayed on the touch screen display in a portrait view or a landscape view based on an analysis of data received from the one or more accelerometers.

In some embodiments, the software components stored in memory 102 may include an operating system 126, a communication module (or set of instructions) 128, a contact/motion module (or set of instructions) 130, a graphics module (or set of instructions) 132, a text input module (or set of instructions) 134, a Global Positioning System (GPS) module (or set of instructions) 135, and applications (or set of instructions) 136.

The operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 128 facilitates communication with other devices over one or more external ports 124 and also includes various software components for handling data received by the RF circuitry 108 and/or the external port 124. The external port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Computer, Inc.) devices.

The contact/motion module 130 may detect contact with the touch screen 112 (in conjunction with the display controller 156) and other touch sensitive devices (e.g., a touchpad or physical click wheel). The contact/motion module 130 includes various software components for performing various operations related to detection of contact, such as determining if contact has occurred, determining if there is movement of the contact and tracking the movement across the touch screen 112, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). In some embodiments, the contact/motion module 130 and the display controller 156 also detects contact on a touchpad. In some embodiments, the contact/motion module 130 and the controller 160 detects contact on a click wheel.

The graphics module 132 includes various known software components for rendering and displaying graphics on the touch screen 112, including components for changing the intensity of graphics that are displayed. As used herein, the term “graphics” includes any object that can be displayed to a user, including without limitation text, web pages, icons (such as user-interface objects including soft keys), digital images, videos, animations and the like.

The text input module 134, which may be a component of graphics module 132, provides soft keyboards for entering text in various applications (e.g., contacts 137, e-mail 140, IM 141, blogging 142, browser 147, and any other application that needs text input).

The GPS module 135 determines the location of the device and provides this information for use in various applications (e.g., to telephone 138 for use in location-based dialing, to camera 143 and/or blogger 142 as picture/video metadata, and to applications that provide location-based services such as weather widgets, local yellow page widgets, and map/navigation widgets).

The applications 136 may include the following modules (or sets of instructions), or a subset or superset thereof:
a contacts module 137 (sometimes called an address book or contact list);
a telephone module 138;
a video conferencing module 139;
an e-mail client module 140;
an instant messaging (IM) module 141;
a blogging module 142;
a camera module 143 for still and/or video images;
an image management module 144;
a video player module 145;
a music player module 146;
a browser module 147;
a calendar module 148;
widget modules 149, which may include weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module 145 and music player module 146;
notes module 153; and/or
map module 154.

Examples of other applications 136 that may be stored in memory 102 include other word processing applications, JAVA-enabled applications, encryption, digital rights management, voice recognition, and voice replication.

In conjunction with touch screen 112, display controller 156, contact module 130, graphics module 132, and text input module 134, the contacts module 137 may be used to manage an address book or contact list, including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch screen 112, display controller 156, contact module 130, graphics module 132, and text input module 134, the telephone module 138 may be used to enter a sequence of characters corresponding to a telephone number, access one or more telephone numbers in the address book 137, modify a telephone number that has been entered, dial a respective telephone number, conduct a conversation and disconnect or hang up when the conversation is completed. As noted above, the wireless communication may use any of a plurality of communications standards, protocols and technologies.

In conjunction with RF circuitry 108, audio circuitry 110, speaker 111, microphone 113, touch screen 112, display controller 156, optical sensor 164, optical sensor controller 158, contact module 130, graphics module 132, text input module 134, contact list 137, and telephone module 138, the videoconferencing module 139 may be used to initiate, conduct, and terminate a video conference between a user and one or more other participants.

In conjunction with RF circuitry 108, touch screen 112, display controller 156, contact module 130, graphics module 132, and text input module 134, the e-mail client module 140 may be used to create, send, receive, and manage e-mail. In conjunction with image management module 144, the e-mail module 140 makes it very easy to create and send e-mails with still or video images taken with camera module 143.

In conjunction with RF circuitry 108, touch screen 112, display controller 156, contact module 130, graphics module 132, and text input module 134, the instant messaging module 141 may be used to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages. In some embodiments, transmitted and/or received instant messages may include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact module 130, graphics module 132, text input module 134, image management module 144, and browsing module 147, the blogging module 142 may be used to send text, still images, video, and/or other graphics to a blog (e.g., the user's blog).

In conjunction with touch screen 112, display controller 156, optical sensor(s) 164, optical sensor controller 158, contact module 130, graphics module 132, and image management module 144, the camera module 143 may be used to capture still images or video (including a video stream) and store them into memory 102, modify characteristics of a still image or video, or delete a still image or video from memory 102.

In conjunction with touch screen 112, display controller 156, contact module 130, graphics module 132, text input module 134, and camera module 143, the image management module 144 may be used to arrange, modify or otherwise manipulate, label, delete, present (e.g., in a digital slide show or album), and store still and/or video images.

In conjunction with touch screen 112, display controller 156, contact module 130, graphics module 132, audio circuitry 110, and speaker 111, the video player module 145 may be used to display, present or otherwise play back videos (e.g., on the touch screen or on an external, connected display via external port 124).

In conjunction with touch screen 112, display system controller 156, contact module 130, graphics module 132, audio circuitry 110, speaker 111, RF circuitry 108, and browser module 147, the music player module 146 allows the user to download and play back recorded music and other sound files stored in one or more file formats, such as MP3 or AAC files. In some embodiments, the device 100 may include the functionality of an MP3 player, such as an iPod (trademark of Apple Computer, Inc.).

In conjunction with RF circuitry 108, touch screen 112, display system controller 156, contact module 130, graphics module 132, and text input module 134, the browser module 147 may be used to browse the Internet, including searching, linking to, receiving, and displaying web pages or portions thereof, as well as attachments and other files linked to web pages.

In conjunction with RF circuitry 108, touch screen 112, display system controller 156, contact module 130, graphics module 132, text input module 134, e-mail module 140, and browser module 147, the calendar module 148 may be used to create, display, modify, and store calendars and data associated with calendars (e.g., calendar entries, to do lists, etc.).

In conjunction with RF circuitry 108, touch screen 112, display system controller 156, contact module 130, graphics module 132, text input module 134, and browser module 147, the widget modules 149 are mini-applications that may be downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display system controller 156, contact module 130, graphics module 132, text input module 134, and browser module 147, the widget creator module 150 may be used by a user to create widgets (e.g., turning a user-specified portion of a web page into a widget).

In conjunction with touch screen 112, display system controller 156, contact module 130, graphics module 132, and text input module 134, the search module 151 may be used to search for text, music, sound, image, video, and/or other files in memory 102 that match one or more search criteria (e.g., one or more user-specified search terms).

In conjunction with touch screen 112, display controller 156, contact module 130, graphics module 132, and text input module 134, the notes module 153 may be used to create and manage notes, to do lists, and the like.

In conjunction with RF circuitry 108, touch screen 112, display system controller 156, contact module 130, graphics module 132, text input module 134, GPS module 135, and browser module 147, the map module 154 may be used to receive, display, modify, and store maps and data associated with maps (e.g., driving directions; data on stores and other points of interest at or near a particular location; and other location-based data).

Each of the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. For example, video player module 145 may be combined with music player module 146 into a single module (e.g., video and music player module 152, FIG. 1B). In some embodiments, memory 102 may store a subset of the modules and data structures identified above. Furthermore, memory 102 may store additional modules and data structures not described above.

In some embodiments, the device 100 is a device where operation of a predefined set of functions on the device is performed exclusively through a touch screen 112 and/or a touchpad. By using a touch screen and/or a touchpad as the primary input/control device for operation of the device 100, the number of physical input/control devices (such as push buttons, dials, and the like) on the device 100 may be reduced.

The predefined set of functions that may be performed exclusively through a touch screen and/or a touchpad include navigation between user interfaces. In some embodiments, the touchpad, when touched by the user, navigates the device 100 to a main, home, or root menu from any user interface that may be displayed on the device 100. In such embodiments, the touchpad may be referred to as a “menu button.” In some other embodiments, the menu button may be a physical push button or other physical input/control device instead of a touchpad.

FIG. 2 illustrates a portable multifunction device 100 having a touch screen 112 in accordance with some embodiments. The touch screen may display one or more graphics within user interface (UI) 200. In this embodiment, as well as others described below, a user may select one or more of the graphics by making contact or touching the graphics, for example, with one or more fingers 202 (not drawn to scale in the figure). In some embodiments, selection of one or more graphics occurs when the user breaks contact with the one or more graphics. In some embodiments, the contact may include a gesture, such as one or more taps, one or more swipes (from left to right, right to left, upward and/or downward) and/or a rolling of a finger (from right to left, left to right, upward and/or downward) that has made contact with the device 100. In some embodiments, inadvertent contact with a graphic may not select the graphic. For example, a swipe gesture that sweeps over an application icon may not select the corresponding application when the gesture corresponding to selection is a tap.

The device 100 may also include one or more physical buttons, such as “home” or menu button 204. As described previously, the menu button 204 may be used to navigate to any application 136 in a set of applications that may be executed on the device 100. Alternatively, in some embodiments, the menu button is implemented as a soft key in a GUI in touch screen 112.

In one embodiment, the device 100 includes a touch screen 112, a menu button 204, a push button 206 for powering the device on/off and locking the device, volume adjustment button(s) 208, a Subscriber Identity Module (SIM) card slot 210, a head set jack 212, and a docking/charging external port 124. The push button 206 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, the device 100 also may accept verbal input for activation or deactivation of some functions through the microphone 113.

Attention is now directed towards embodiments of user interfaces (“UI”) and associated processes that may be implemented on a portable multifunction device 100.

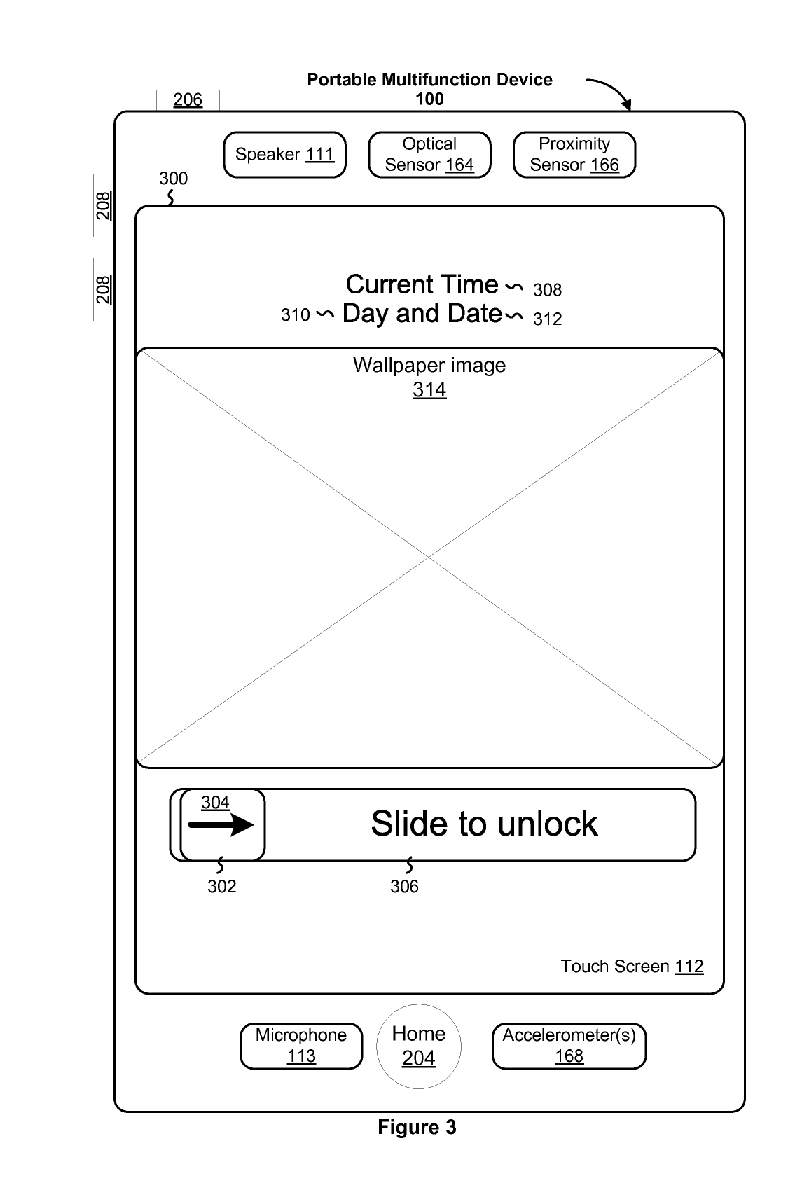

FIG. 3 illustrates an exemplary user interface for unlocking a portable electronic device in accordance with some embodiments. In some embodiments, user interface 300 includes the following elements, or a subset or superset thereof:
Unlock image 302 that is moved with a finger gesture to unlock the device;
Arrow 304 that provides a visual cue to the unlock gesture;
Channel 306 that provides additional cues to the unlock gesture;
Time 308;
Day 310;
Date 312; and
Wallpaper image 314.

In some embodiments, the device detects contact with the touch-sensitive display (e.g., a user's finger making contact on or near the unlock image 302) while the device is in a user-interface lock state. The device moves the unlock image 302 in accordance with the contact. The device transitions to a user-interface unlock state if the detected contact corresponds to a predefined gesture, such as moving the unlock image across channel 306. Conversely, the device maintains the user-interface lock state if the detected contact does not correspond to the predefined gesture. As noted above, processes that use gestures on the touch screen to unlock the device are described in U.S. patent application Ser. Nos. 11/322,549, “Unlocking A Device By Performing Gestures On An Unlock Image,” filed Dec. 23, 2005, and 11/322,550, “Indication Of Progress Towards Satisfaction Of A User Input Condition,” filed Dec. 23, 2005, which are hereby incorporated by reference herein in their entirety.

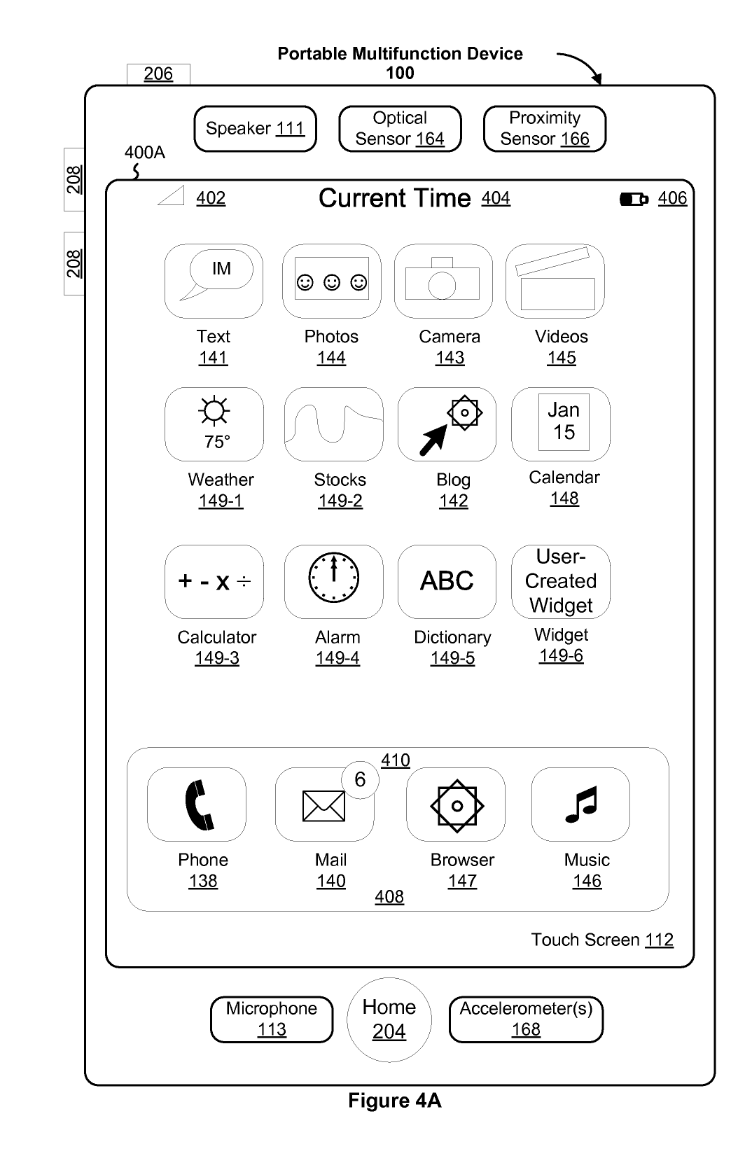

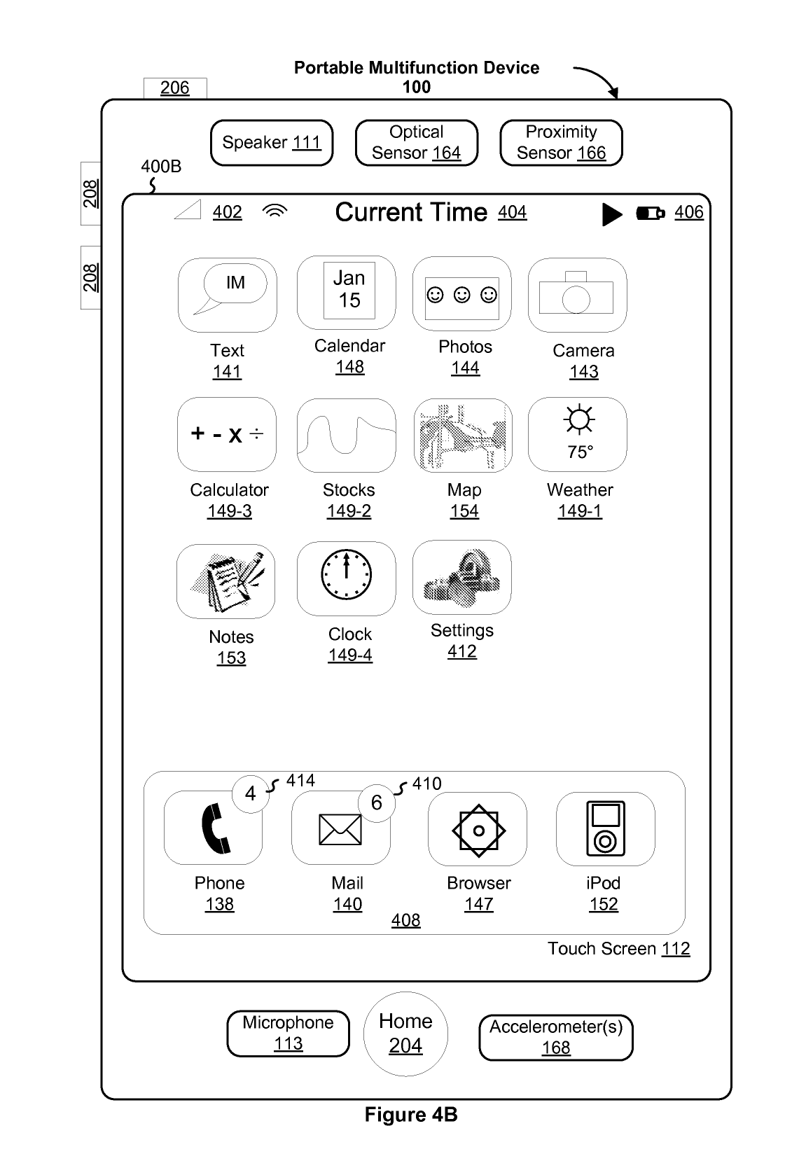

FIGS. 4A and 4B illustrate exemplary user interfaces for a menu of applications on a portable multifunction device in accordance with some embodiments. In some embodiments, user interface 400A includes the following elements, or a subset or superset thereof:
Signal strength indicator(s) 402 for wireless communication(s), such as cellular and Wi-Fi signals;
Time 404;
Battery status indicator 406;
Tray 408 with icons for frequently used applications, such as:
   Phone 138, which may include an indicator 414 of the number of missed calls or voicemail messages;
   E-mail client 140, which may include an indicator 410 of the number of unread e-mails;
   Browser 147; and
   Music player 146; and
Icons for other applications, such as:
   IM 141;
   Image management 144;
   Camera 143;
   Video player 145;
   Weather 149-1;
   Stocks 149-2;
   Blog 142;
   Calendar 148;
   Calculator 149-3;
   Alarm clock 149-4;
   Dictionary 149-5; and
   User-created widget 149-6.

In some embodiments, user interface 400B includes the following elements, or a subset or superset thereof:
402, 404, 406, 141, 148, 144, 143, 149-3, 149-2, 149-1, 149-4, 410, 414, 138, 140, and 147, as described above;
Map 154;
Notes 153;
Settings 412, which provides access to settings for the device 100 and its various applications 136; and
Video and music player module 152, also referred to as iPod (trademark of Apple Computer, Inc.) module 152.

In some embodiments, UI 400A or 400B displays all of the available applications 136 on one screen so that there is no need to scroll through a list of applications (e.g., via a scroll bar). In some embodiments, as the number of applications increase, the icons corresponding to the applications may decrease in size so that all applications may be displayed on a single screen without scrolling. In some embodiments, having all applications on one screen and a menu button enables a user to access any desired application with at most two inputs, such as activating the menu button 204 and then activating the desired application (e.g., by a tap or other finger gesture on the icon corresponding to the application).

In some embodiments, UI 400A or 400B provides integrated access to both widget-based applications and non-widget-based applications. In some embodiments, all of the widgets, whether user-created or not, are displayed in UI 400A or 400B. In other embodiments, activating the icon for user-created widget 149-6 may lead to another UI that contains the user-created widgets or icons corresponding to the user-created widgets.

In some embodiments, a user may rearrange the icons in UI 400A or 400B, e.g., using processes described in U.S. patent application Ser. No. 11/459,602, “Portable Electronic Device With Interface Reconfiguration Mode,” filed Jul. 24, 2006, which is hereby incorporated by reference herein in its entirety. For example, a user may move application icons in and out of tray 408 using finger gestures.

In some embodiments, UI 400A or 400B includes a gauge (not shown) that displays an updated account usage metric for an account associated with usage of the device (e.g., a cellular phone account), as described in U.S. patent application Ser. No. 11/322,552, “Account Information Display For Portable Communication Device,” filed Dec. 23, 2005, which is hereby incorporated by reference herein in its entirety.

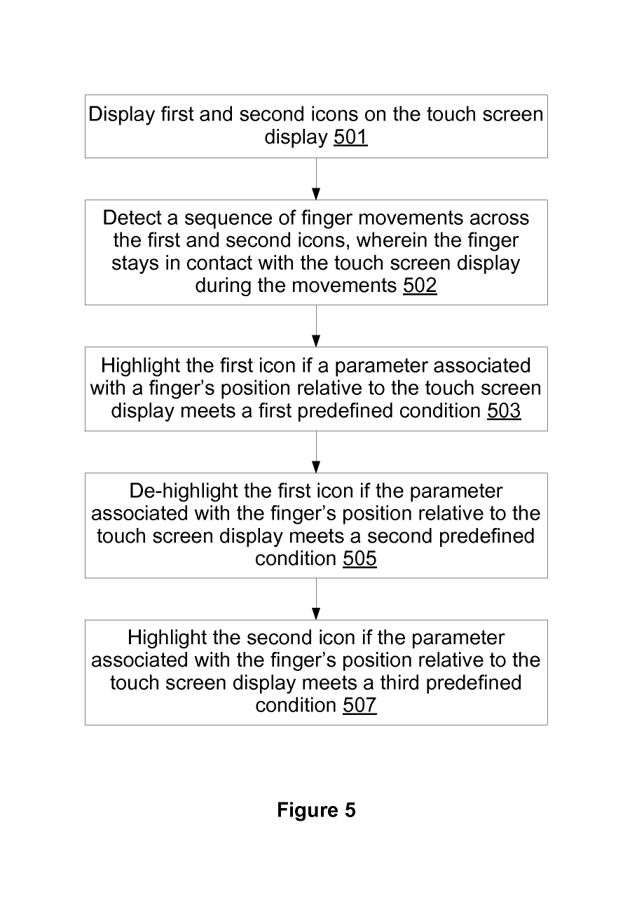

FIG. 5 is a flow diagram illustrating a first process for highlighting/de-highlighting some key icons of a soft keyboard in response to finger contacts with the soft keyboard in accordance with some embodiments.

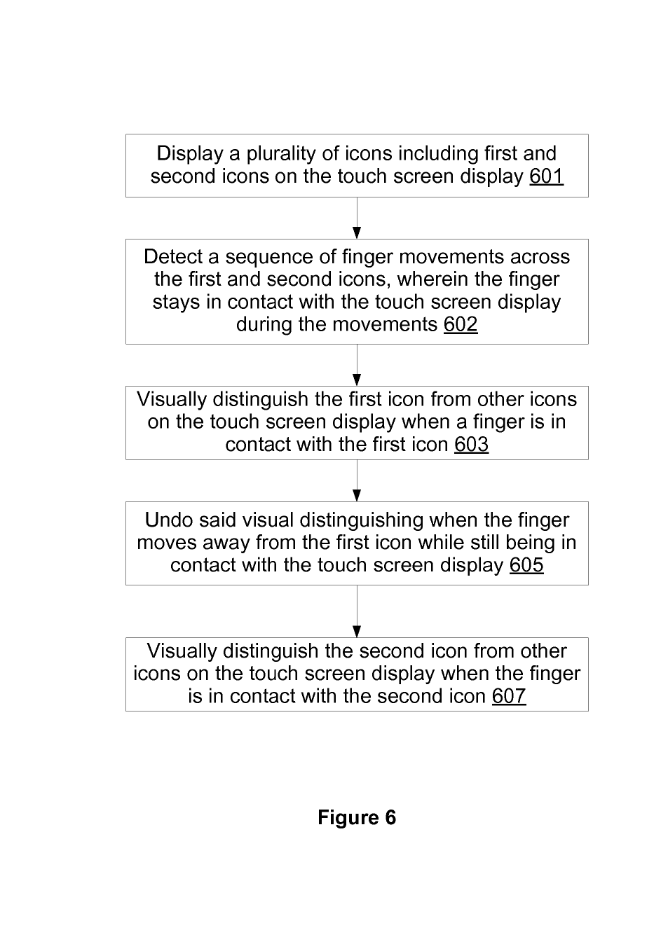

FIG. 6 is a flow diagram illustrating a second process for visually distinguishing some key icons over other key icons of a soft keyboard in response to finger contacts with the soft keyboard in accordance with some embodiments.

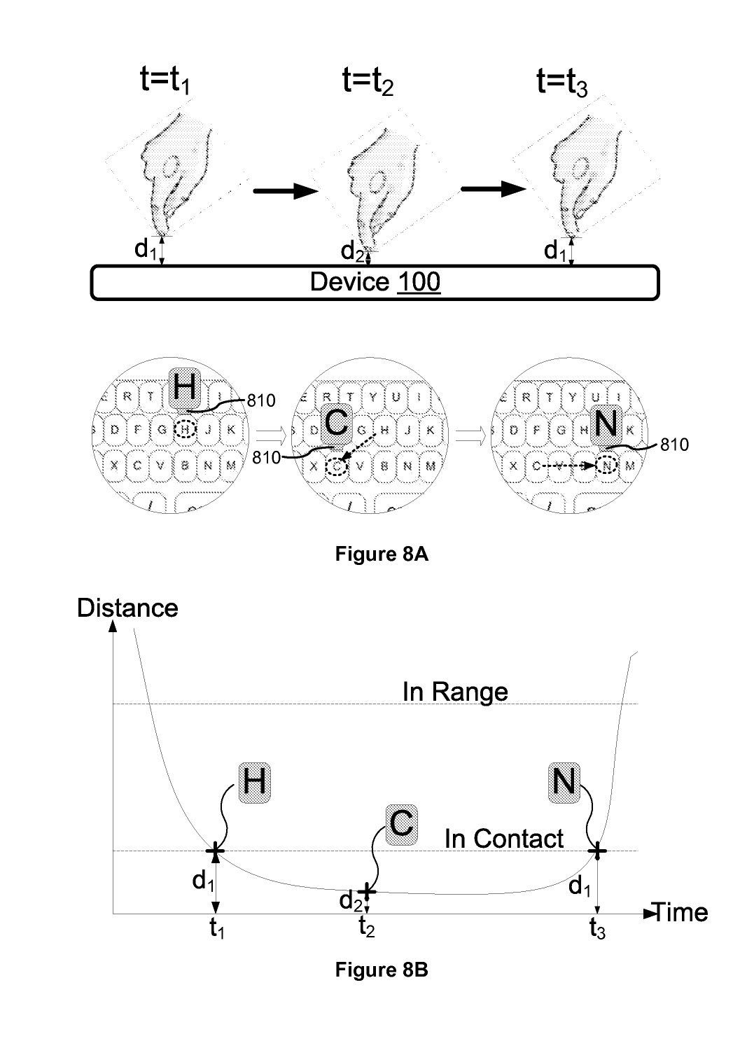

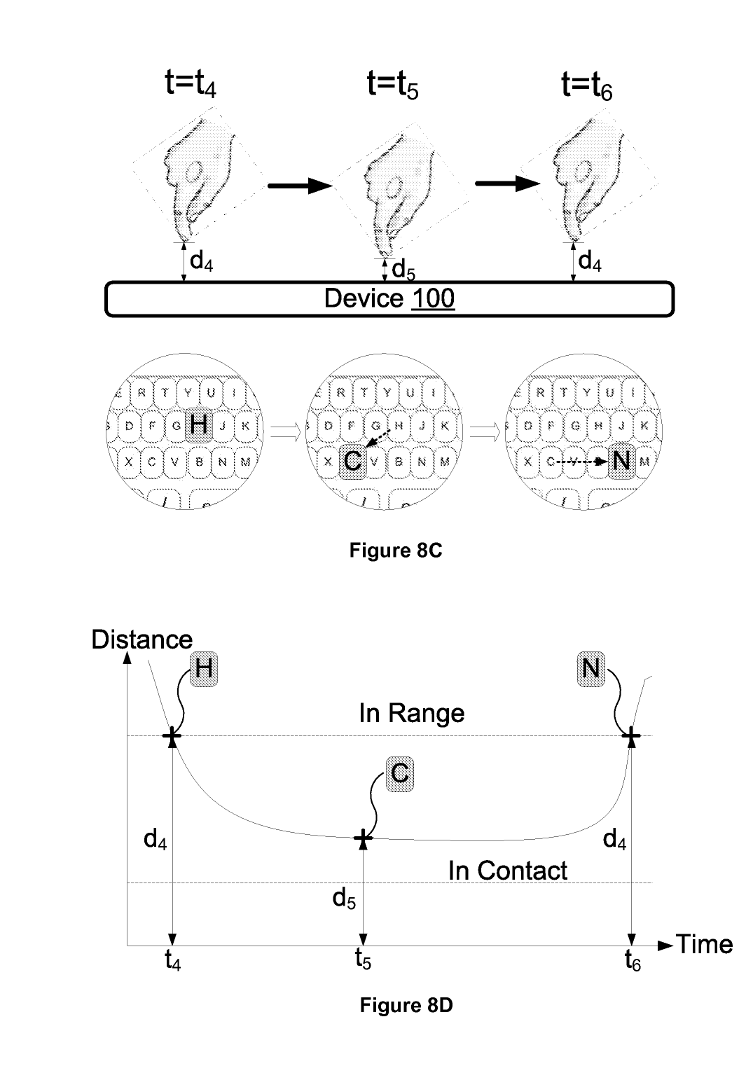

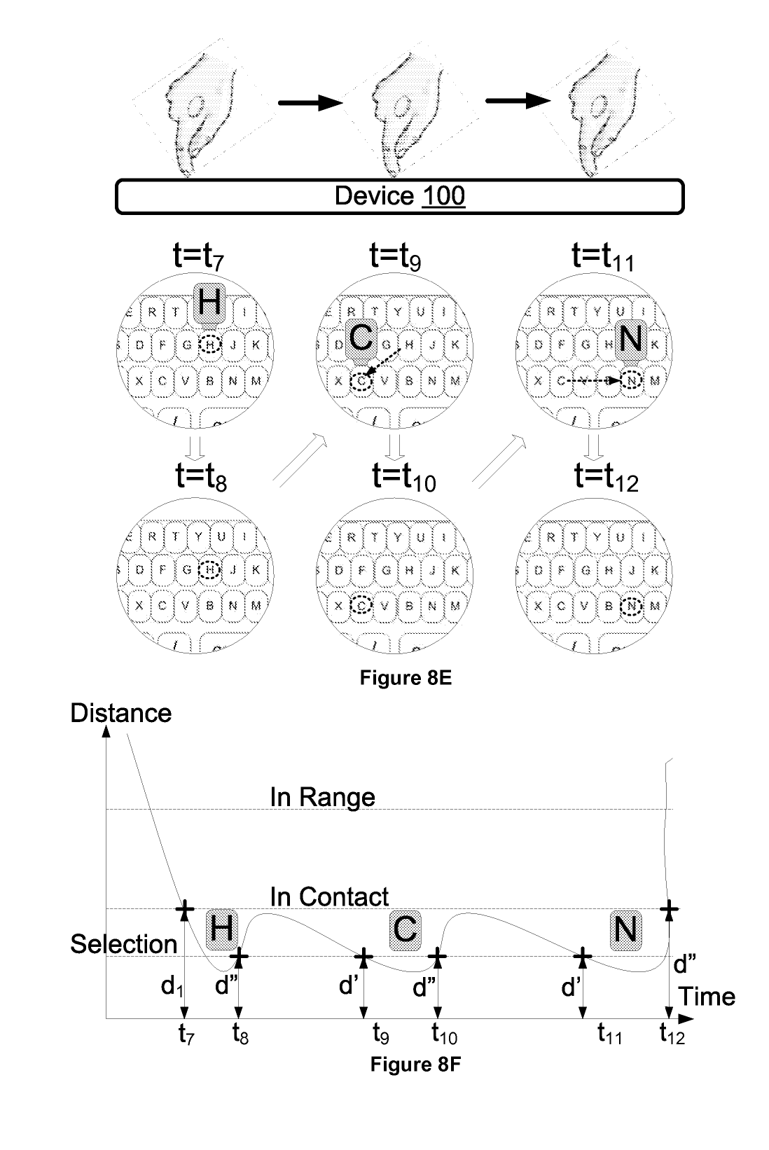

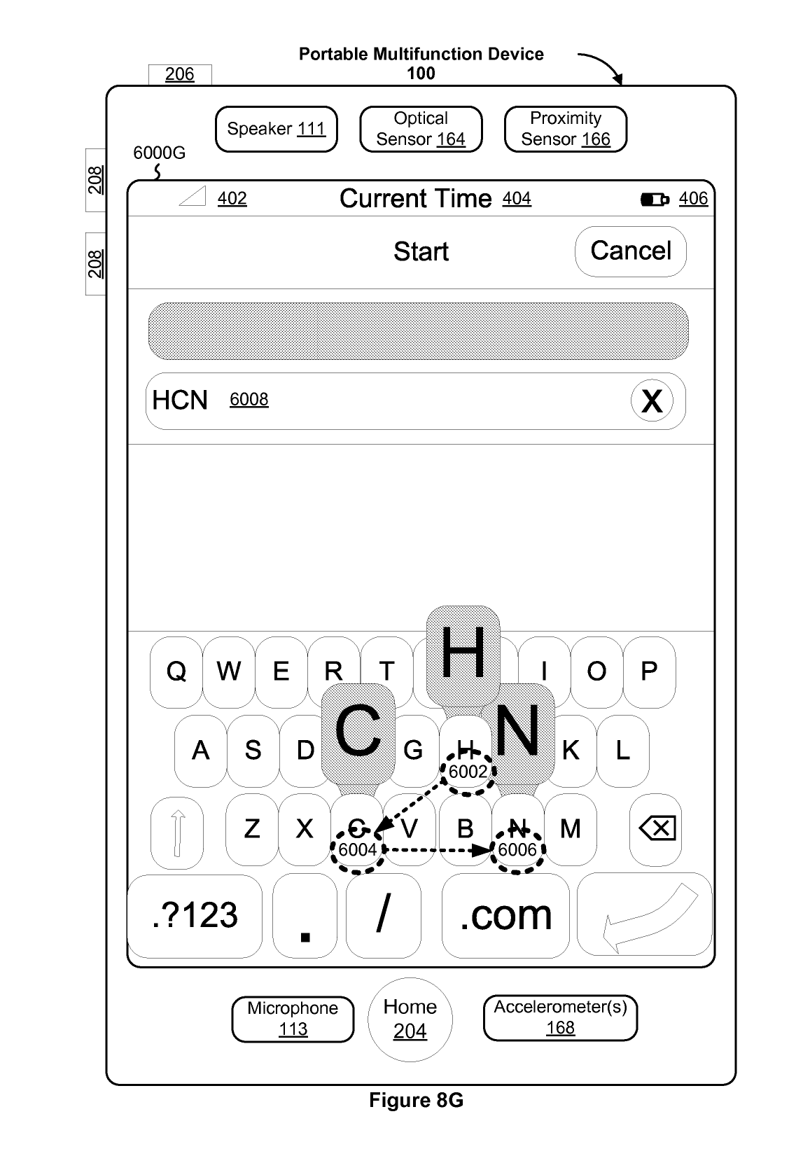

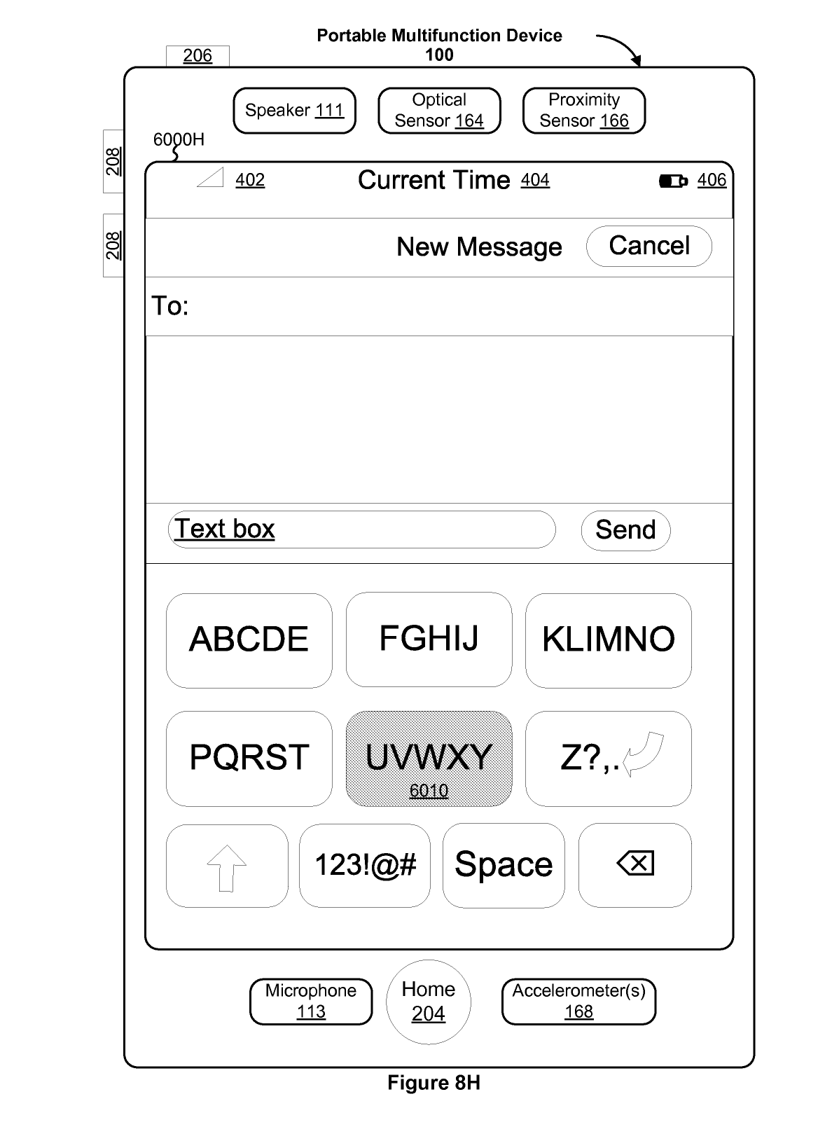

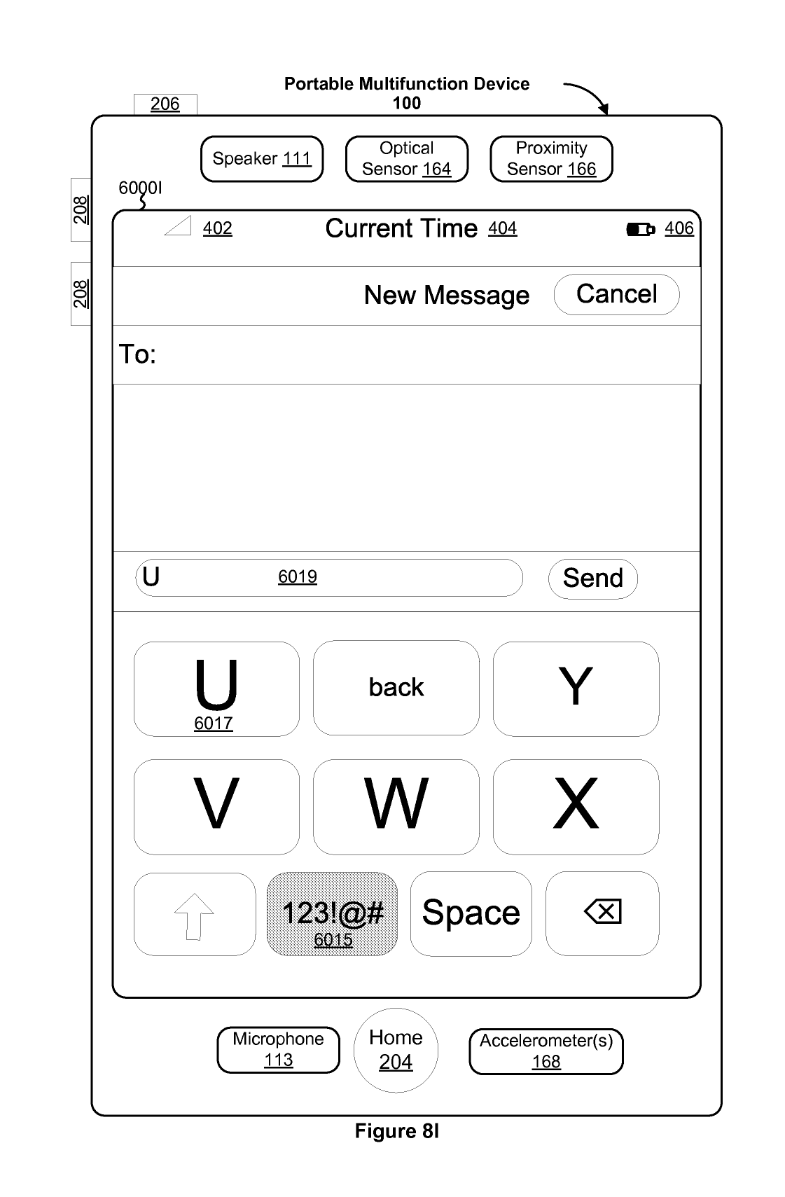

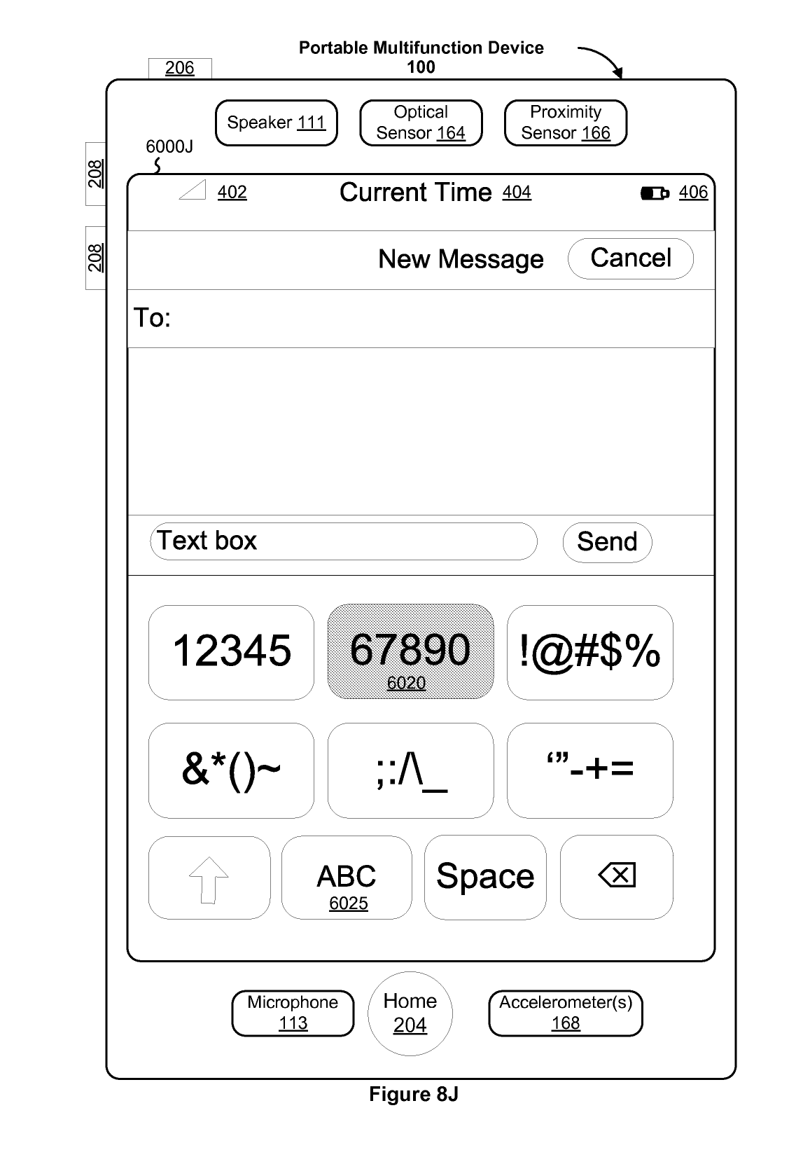

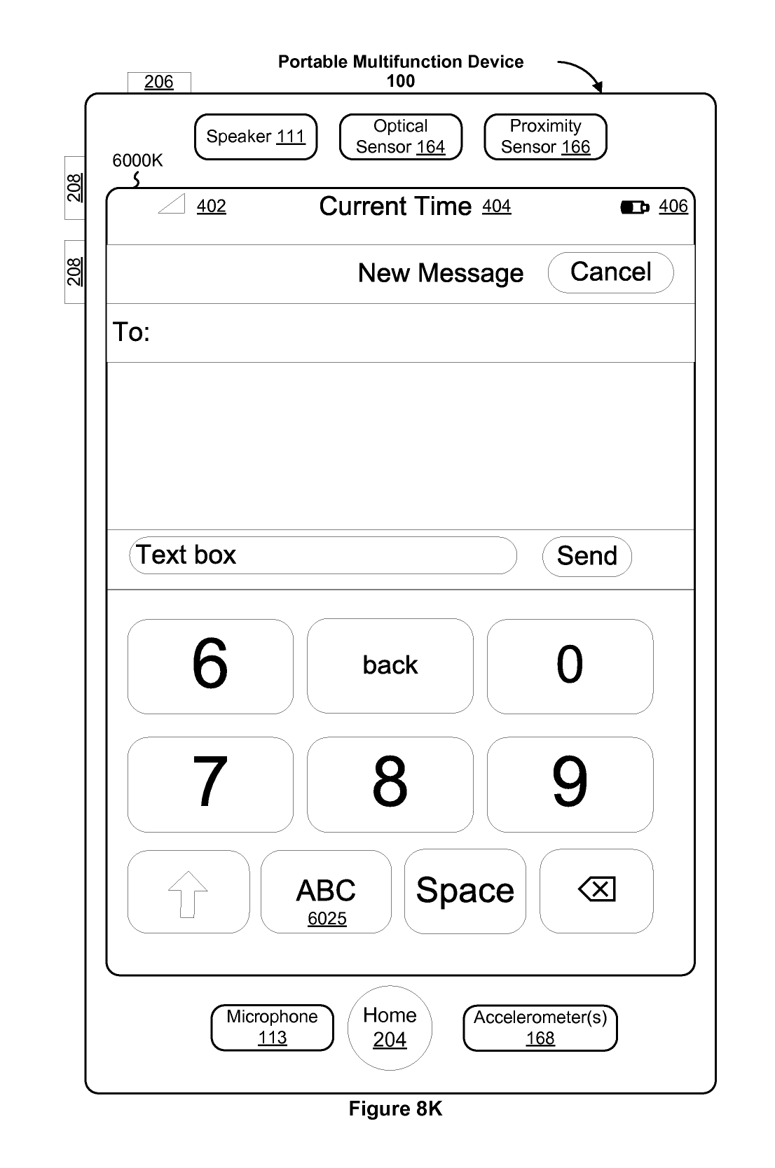

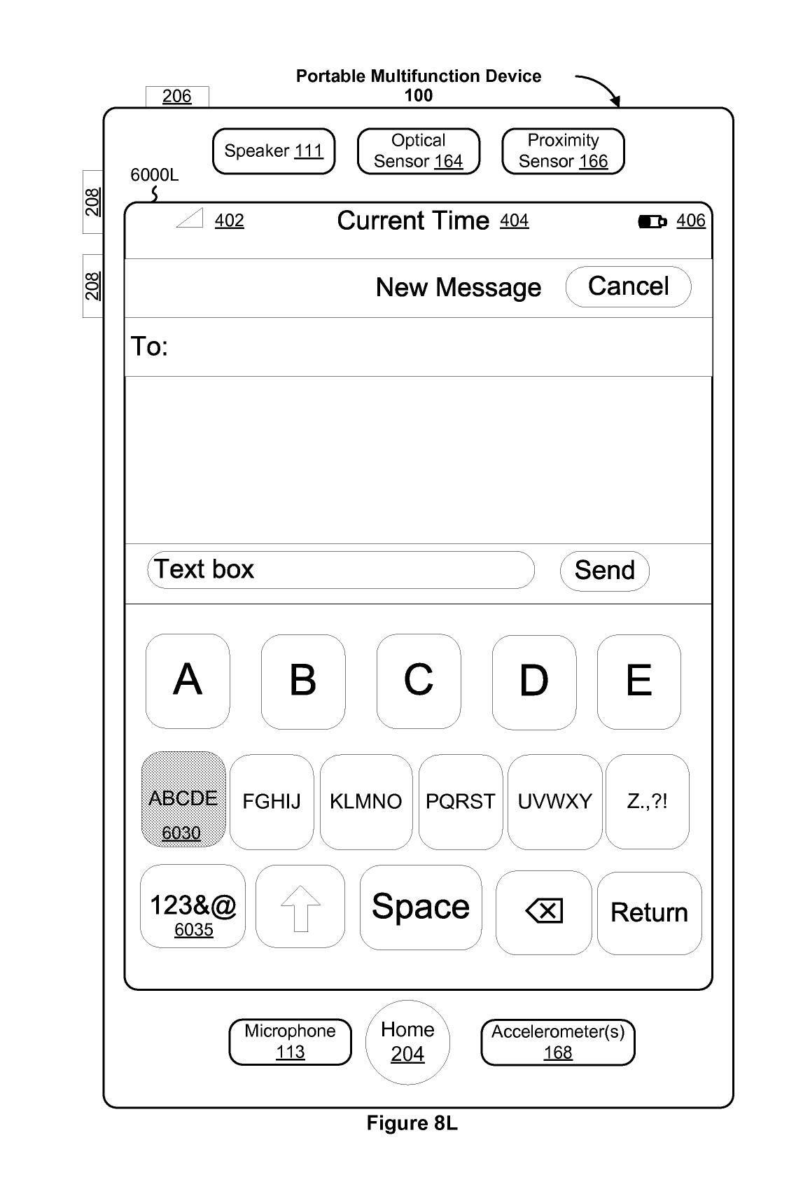

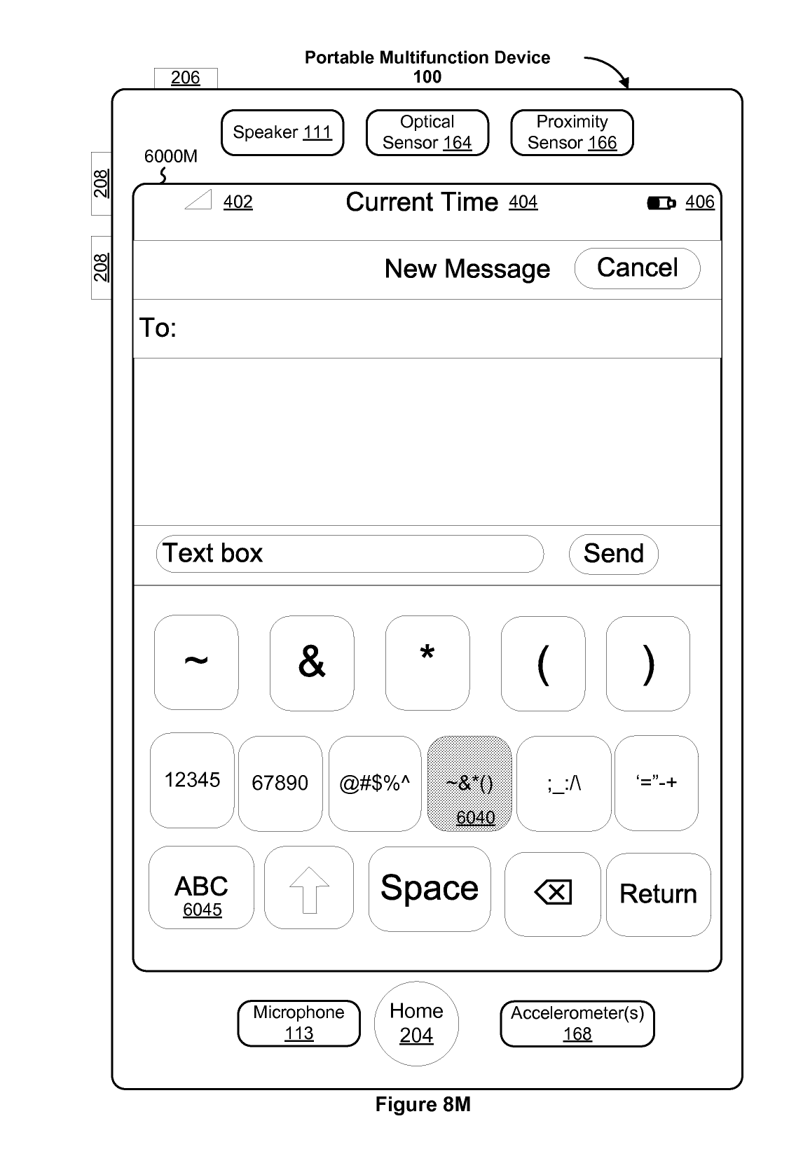

FIGS. 8A through 8G illustrate exemplary user interfaces for displaying on a touch screen display a soft keyboard including multiple key icons (501, 601) and changing the appearance of one or more of the key icons in response to a finger movement on or near the soft keyboard in accordance with some embodiments. The soft keyboard includes a first key icon corresponding to the letter “H”, a second key icon corresponding to the letter “C”, and a third key icon corresponding to the letter “N”.

When a user applies a finger swipe on the touch screen's surface, the portable device detects a sequence of finger movements across the first and second icons (502, 602). In some embodiments (FIG. 8B), the finger stays in contact with the touch screen display during the movements. In some other embodiments (FIG. 8D), the finger stays within a range from the touch screen display during the movements.

At t=t₁ (FIG. 8A), a finger-in-contact event is detected at the first key icon and the first key icon is highlighted (503). In some embodiments, the first key icon is “highlighted” if the portable device displays the first key icon in a manner visually different from other key icons that are not highlighted (603).

In some embodiments, the first key icon is highlighted by displaying a symbol near the first key icon. As shown in FIG. 8A, the symbol is a magnified instance of the first key icon. The magnified instance may have different colors from the soft keyboard. A visual link between the magnified instance and the first key icon (e.g., the small trapezoid stub 810 in FIG. 8A) is shown to visualize their relationship.

In some embodiments, the fact that a key icon is highlighted does not necessarily mean that the user has selected the key icon. A different or additional finger movement may be needed to complete the user selection of the key icon. For example, some embodiments require that a user select a key icon through a finger-out-of-contact event at the key icon and some other embodiments require that a user select a key icon through a finger-out-of-range event at the key icon. The user initiated event that selects a key icon may also be called a key selection event, a finger-up event, a finger-lift event, or the like. When the key selection event occurs, a letter corresponding to the user-selected key icon is entered into a predefined location on the display (e.g., in a text input field). As shown in FIG. 8B, the user-selected key icon does not have to be (but can be) the one at which the initial finger-in-contact event and/or finger-in-range event occur. In some embodiments, a portable device may support multiple key selection mechanisms at the same time as long as there is no conflict between one and another.

Referring back to FIG. 8A, after the finger moves outside a predefined range around the first key icon, the portable device de-highlights the first key icon (505) or undoes any visual distinguishing effects it applied to the first key icon previously (605). As shown in FIG. 8B, although the finger moves away from the first key icon, it is still in contact with the touch screen display. In other words, no finger-out-of-contact event is detected yet after the initial finger-in-contact event at t=t₁.

In some embodiments, the first key icon is de-highlighted by removing the symbol near the first key icon. Sometimes, the symbol remains on the touch screen for a predefined brief time period (e.g., a predefined time period of at least 0.2 second and less than 1.0 second), after the finger moves away from the first key icon and then disappears. Therefore any key icon that is highlighted, is highlighted for at least the predefined brief period of time.

The second key icon gets highlighted (507) if the finger moves into a predefined range around the second key icon at t=t₂ while still in continuous contact with the touch screen. In some embodiments, the second key icon is “highlighted” if the portable device displays the second key icon in a manner visually different from other key icons that are not highlighted (607).

In some embodiments, the second key icon is highlighted by displaying a symbol near the second key icon. As shown in FIG. 8A, the symbol is a magnified instance of the second key icon. A visual link between the magnified instance and the second key icon (e.g., the small trapezoid stub 810 in FIG. 8A) is shown to visualize their relationship.

The aforementioned series of operations repeat themselves until a finger-out-of-contact event is detected at a particular location (e.g., the location occupied by the third key icon) on the touch screen at t=t₃.

In some embodiments, the finger-out-of-contact event occurs when the finger is lifted off the touch screen display. The finger-out-of-contact event causes the device 100 to identify a key icon at which the finger-out-of-contact event occurs and a copy of the letter corresponding to the user-selected key icon is displayed at a predefined location on the touch screen display.

In some embodiments, a finger does not have to be in physical contact with the touch screen to highlight a key icon. FIGS. 8C and 8D depict that the first key icon is highlighted by being displayed in a visually different manner from other key icons (e.g., using different colors or shapes or both) when the finger is within a predefined distance d₄ from the first key icon at t=t₄. When the finger moves away from the key icon, but still within a predefined range from the display (as shown in FIG. 8D), the first key icon resumes its original appearance. Similarly, the second key icon gets highlighted when the finger is moved above the second key icon at t=t₅.

In some embodiments, another parameter other than the distance between a finger and the touch screen is used to define the relationship between the finger and the touch screen. This parameter may be a function of one or more parameters such as a finger pressure, a finger contact area, a voltage, or a capacitance between the finger and the touch screen display. Sometimes, one or more of the parameters may be combined for defining the relationship between the finger and the touch screen. For example, a key icon is highlighted or selected only if at least two different parameters associated with the finger contact area and capacitance indicate that the key icon has been highlighted or selected.

In some embodiments, a sequence of key icons is selected without any finger-out-of-contact event being detected if another threshold level is used for measuring the parameter associated with the finger and the display (e.g., the distance as shown in FIG. 8F). In this case, the device compares the distance with a new “selection” threshold level.

At t=t₇, the first key icon “H” is highlighted if the finger meets a first predefined condition, e.g., if the finger is in contact with the touch screen display. At t=t₈, the first key icon “H” is selected when the finger meets a second predefined condition and the finger remains within a predefined distance from the touch screen display. In some embodiments, the second predefined condition is that the distance between the finger and the touch screen display increases above the “selection” threshold level. As a result, a copy of the selected key icon is entered at a predefined location on the touch screen display.

At t=t₉, the second key icon “C” is highlighted when the distance between the finger and the touch screen display decreases below the “selection” threshold level. At t=t₁₀, the second key icon “C” is selected when the distance between the finger and the touch screen display once again increases above the “selection” threshold level.

The aforementioned operations repeat themselves until a finger-out-of-contact event is detected at t=t₁₂.

The embodiments described above treat a highlighted key icon differently from a user-selected key icon. A key icon has to be first highlighted before being selected. In other words, a highlighted key icon is used to alert the user of what is going to be selected if the user chooses to lift his or her finger off the touch screen at the current location.

In some other embodiments, the portable device does not highlight a key icon to give the user an alert in advance as described above. Instead, a key icon gets highlighted only if the user has selected the key icon. Thus, there is no distinction between a highlighted key icon and a user-selected key icon. The processes described above can be slightly modified to implement these other embodiments. For example, in response to a finger swipe on the touch screen as shown in FIG. 8A, rather than displaying three balloon-style symbols, the portable device only highlights the last one associated with the letter “N” on the touch screen to remind the user of the key icon he or she has selected and displays a copy of the letter “N” in a text input field on the touch screen. Similarly, only the third key icon corresponding to the letter “N” is highlighted in a visually distinguishing manner in FIG. 8C.

FIG. 8G is an exemplary graphical user interface illustrating a character string “HCN” is entered into the text field 6008 when the finger moves from position 6002 to 6004 and then to 6006. The three balloon-style symbols are displayed temporarily when the finger is in contact with their corresponding key icons on the soft keyboard. Advantageously, the aforementioned character input approach is faster than conventional approaches in which a user has to completely break a finger contact with the touch screen in order to enter a user-selected character.

Note that the distances between the finger and the touch screen display shown in FIGS. 8A through 8F may be exaggerated for illustrative purpose.

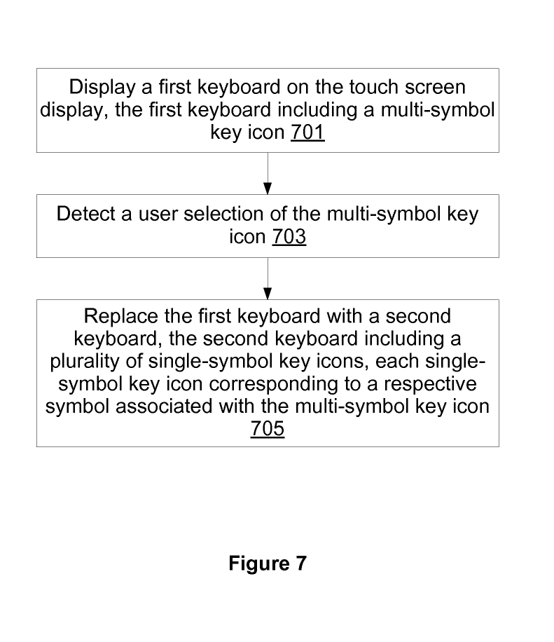

A challenge for the soft keyboard shown in FIG. 8G is that the size of the key icons may be too small to select for some users. Accordingly, FIGS. 8H-8M are exemplary graphical user interfaces illustrating different types of soft keyboards in accordance with some embodiments. These soft keyboards have larger key icons and are therefore more convenient for those users having difficulty with keyboards like that shown in FIG. 8G. FIG. 7 is a flow diagram illustrating a process for switching between soft keyboards in response to finger contacts with the soft keyboards in accordance with some embodiments.

In response to a user request for soft keyboard, the portable device displays a first keyboard on the touch screen display (701). The first keyboard includes at least one multi-symbol key icon (i.e., one key icon that corresponds to multiple symbols and a user selection of the multi-symbol key icon does not render an immediate selection of one of the multiple symbols).

In some embodiments (as shown in FIG. 8H), the first soft keyboard includes multiple multi-symbol key icons. For example, the key icon 6010 includes five symbols “U”, “V”, “W”, “X”, and “Y”.

Upon detecting a user selection of the multi-symbol key icon (703), the device replaces the first keyboard with a second keyboard (705). The second keyboard includes a plurality of single-symbol key icons and each single-symbol key icon corresponds to a respective symbol associated with the multi-symbol key icon.

FIG. 8I depicts a second keyboard replacing the first keyboard shown in FIG. 8H. Note that the top two rows of six multi-symbol key icons are replaced by two rows of five single-symbol key icons and a “back” key icon. Each of the five single-symbol key icons includes one symbol from the multi-symbol key icon 6010.

In response to a user selection of one of the single-symbol key icons, an instance of a symbol associated with the user-selected single-symbol key icon is displayed at a predefined location on the touch screen display.

For example, as shown in FIG. 8I, in response to a user selection of the single-symbol key icon 6017, a letter “U” is entered into the text field 6019. A user can easily tap any of the five single-symbol key icons because they are quite large. To return to the first keyboard with multi-symbol key icons, the user can finger tap the back key icon at the center of the top row of the second keyboard. In some embodiments, the portable device automatically brings back the first keyboard with the multi-symbol key icon after a user selection of a single-symbol key icon in the second keyboard.

To enter a non-alphabetic character, the user can tap the keyboard switch icon 6015. As shown in FIG. 8J, a third soft keyboard replaces the second keyboard shown in FIG. 8I. In particular, each of the top two rows is a multi-symbol key icon including multiple non-alphabetic characters. For example, the key icon 6020 includes five digit symbols “6”, “7”, “8”, “9”, and “0”.

A user selection of the key icon 6020 replaces the third keyboard with the fourth keyboard shown in FIG. 8K. Note that the top two rows of six multi-symbol key icons are now replaced by two rows of five single-symbol key icons and a back key icon. Each of the five single-symbol key icons includes one digit symbol from the multi-symbol key icon 6020. A finger tap of the keyboard switch icon 6025 brings back the alphabetic multi-symbol keyboard shown in FIG. 8H.

In some embodiments, the top row of a soft keyboard is reserved for those single-symbol key icons and the second row of the keyboard displays multiple multi-symbol key icons.

As shown in FIG. 8L, a user selection of the multi-symbol key icon 6030 causes the top row to display five single-symbol key icons, each icon including one character from the multi-symbol key icon 6030.

In some embodiments, as shown in FIG. 8L, the user-selected multi-symbol key icon 6030 is displayed in a manner visually distinguishable from other icons on the same soft keyboard. The manner may include changing its color, shape or the like.

The keyboard shown in FIG. 8L also includes a keyboard switch icon 6035. Upon detecting a user selection of the keyboard switch icon 35, the device replaces the keyboard with another one as shown in FIG. 8M. Note that the keyboard in FIG. 8M includes another set of multi-symbol key icons such as 6040 in replacement of the multi-symbol key icons shown in the previous keyboard.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method, comprising: at a portable multifunction device with a touch screen display,
displaying a first icon and a second icon on the touch screen display;
detecting a sequence of finger movements across the first and second icons, wherein the finger stays in contact with the touch screen display during the movements;
in response to the sequence of finger movements,
highlighting the first icon for at least a predefined time period if a parameter associated with the finger's position relative to the touch screen display meets a first predefined condition; and
highlighting the second icon for at least the predefined time period if the parameter associated with the finger's position relative to the touch screen display meets a second predefined condition.

2. The method of claim 1, wherein highlighting the first icon includes displaying a first symbol near the first icon.

3. The method of claim 2, wherein the first symbol is a magnified instance of the first icon.

4. The method of claim 2, wherein the first symbol is visually linked to the first icon.

5. The method of claim 1, further comprising: in association with highlighting the second icon,
displaying a symbol corresponding to the second icon at a predefined location on the touch screen display if the finger is lifted off the touch screen display at which the second icon is located.

6. The method of claim 1, wherein the parameter is a function of one or more parameters selected from the group consisting of a distance, a pressure, a contact area, a voltage, and a capacitance between the finger and the touch screen display.

7. A computer-implemented method, comprising: at a portable multifunction device with a touch screen display,
displaying a first icon and a second icon on the touch screen display;
detecting a sequence of finger movements across the first and second icons, wherein the finger stays in contact with the touch screen display during the movements;
in response to the sequence of finger movements,
altering the first icon's appearance for at least a predefined time period when the finger moves within a predefined distance from the first icon and then moves away from the first icon; and
altering the second icon's appearance for at least the predefined time period when the finger moves within the predefined distance from the second icon and then moves away from the second icon.

8. The method of claim 7, wherein altering the first icon's appearance includes changing the first icon's color or shape or both.

9. The method of claim 7, wherein altering the first icon's appearance includes replacing the first icon with a magnified instance of the first icon.

10. The method of claim 7, further comprising delaying resuming the first icon's appearance for the predefined time period after the finger moves away from the first icon.

11. A computer-implemented method, comprising: at a portable multifunction device with a touch screen display,
displaying multiple icons including a first icon and a second icon on the touch screen display;
detecting a sequence of finger movements on the multiple icons, wherein the finger remains in contact with the touch screen display during the sequence of finger movements;
in response to the sequence of finger movements,
highlighting the first icon after a parameter associated with the finger and the touch screen display increases beyond a first predefined threshold level and then decreases below a second predefined threshold level; and
highlighting the second icon after the parameter associated with the finger and the touch screen display increases beyond the first predefined threshold level and then decreases below the second predefined threshold level.

12. The method of claim 11, wherein highlighting the first icon includes displaying a magnified instance of the first icon near the first icon for at least a predefined time period.

13. The method of claim 11, wherein highlighting the first icon includes changing the first icon's appearance for at least a predefined time period.

14. The method of claim 11, wherein highlighting the first icon includes displaying a symbol corresponding to the first icon at a predefined location on the touch screen display.

15. The method of claim 11, wherein the multiple icons are key icons of a soft keyboard.

16. The method of claim 11, wherein the parameter is a function of one or more parameters selected from the group consisting of a distance, a pressure, a contact area, a voltage, and a capacitance between the finger and the touch screen display.

17. A computer-implemented method, comprising: at a portable multifunction device with a touch screen display,
displaying a first keyboard on the touch screen display, the first keyboard including a multi-symbol key icon;
detecting a user selection of the multi-symbol key icon; and
replacing the first keyboard with a second keyboard, the second keyboard including a plurality of single-symbol key icons, each single-symbol key icon corresponding to a respective symbol associated with the multi-symbol key icon.

18. The method of claim 17, further comprising:
detecting a user selection of one of the single-symbol key icons; and
displaying at a predefined location on the touch screen display an instance of a symbol associated with the user-selected single-symbol key icon.

19. The method of claim 17, wherein the second keyboard includes the multi-symbol key icon, and further comprising:
displaying the multi-symbol key icon in a manner visually distinguishable from other icons in the second keyboard.

20. The method of claim 17, wherein the second keyboard includes a back key icon, and further comprising:
replacing the second keyboard with the first keyboard upon detecting a user selection of the back key icon.

21. The method of claim 17, wherein the first keyboard includes a keyboard switch icon, further comprising:
detecting a user selection of the keyboard switch icon; and
replacing the first keyboard with a third keyboard, the third keyboard including a second multi-symbol key icon in replacement of the multi-symbol key icon in the first keyboard.

22. A graphical user interface on a portable electronic device with a touch screen display, comprising:
first and second icons;
wherein, in response to a sequence of finger movements on the touch screen display during which the finger remains in contact with the touch screen display,
the first icon is highlighted if a parameter associated with the finger's position relative to the touch screen display meets a first predefined condition;
the first icon is de-highlighted when the parameter meets a second predefined condition; and
the second icon is highlighted when the parameter meets a third predefined condition.

23. A graphical user interface on a portable electronic device with a touch screen display, comprising:
a first keyboard on the touch screen display, the first keyboard including a multi-symbol key icon; and
a second keyboard on the touch screen display, the second keyboard including a plurality of single-symbol key icons, each single-symbol key icon corresponding to a respective symbol associated with the multi-symbol key icon;
wherein, in response to detecting a user selection of the multi-symbol key icon, the first keyboard is replaced with a second keyboard.

24. A portable electronic device, comprising:
a touch screen display;
one or more processors;
memory; and
one or more programs, wherein the one or more programs are stored in the memory and configured to be executed by the one or more processors, the one or more programs including:
instructions for displaying a first icon and a second icon on the touch screen display;
instructions for detecting a sequence of finger movements across the first and second icons, wherein the finger stays in contact with the touch screen display during the movements;
instructions for, in response to the sequence of finger movements,
highlighting the first icon for at least a predefined time period if a parameter associated with the finger's position relative to the touch screen display meets a first predefined condition; and
highlighting the second icon for at least the predefined time period if the parameter associated with the finger's position relative to the touch screen display meets a second predefined condition.

25. A computer-program product, comprising:
a computer readable storage medium and a computer program mechanism embedded therein, the computer program mechanism comprising instructions that, when executed by a portable electronic device with a touch screen display with a plurality of user interface objects, cause the device to:
display a first icon and a second icon on the touch screen display;
detect a sequence of finger movements across the first and second icons, wherein the finger stays in contact with the touch screen display during the movements;
in response to the sequence of finger movements,
highlight the first icon for at least a predefined time period if a parameter associated with the finger's position relative to the touch screen display meets a first predefined condition; and
highlight the second icon for at least the predefined time period if the parameter associated with the finger's position relative to the touch screen display meets a second predefined condition.

26. A portable electronic device with a touch screen display, comprising:
means for displaying a first icon and a second icon on the touch screen display;
means for detecting a sequence of finger movements across the first and second icons, wherein the finger stays in contact with the touch screen display during the movements;
means for, in response to the sequence of finger movements,
highlighting the first icon for at least a predefined time period if a parameter associated with the finger's position relative to the touch screen display meets a first predefined condition; and
highlighting the second icon for at least the predefined time period if the parameter associated with the finger's position relative to the touch screen display meets a second predefined condition.
